(19) United States
(12) Patent Application Publication
(10) Pub. No.: US 2011/0206250 A1
(43) Pub. Date: Aug. 25, 2011

(54) SYSTEMS, COMPUTER-READABLE MEDIA, AND METHODS FOR THE CLASSIFICATION OF ANOMALIES IN VIRTUAL COLONOGRAPHY MEDICAL IMAGE PROCESSING

(75) Inventors: Ryan McGinnis, Tipp City, OH (US); Robert L. Van Uitert, Hollis, NH (US); Senthil Periaswamy, Acton, MA (US)

(73) Assignee: iCAD, Inc., Nashua, NH (US)

(21) Appl. No.: 12/711,759

(22) Filed: Feb. 24, 2010

(51) Int. Cl. G06K 9/00

(52) U.S. Cl. 382/128

(57) ABSTRACT

This discloses methods and systems for the processing of medical image data of a colon acquired with an imaging device, such as a computerized tomography (“CT”) scanner and more particularly, to methods and systems for the classification of structures or objects in said medical image data. The disclosed methods and systems analyze image data for objects such as rectal tubes or stools, or for clusters of suspicious regions, and may eliminate such objects from further analysis prior to presenting potential polyps to a user.

### FIELD

This application relates generally to the processing of medical image data of a colon acquired with an imaging device, such as a computerized tomography (“CT”) scanner and more particularly, to features of use in the classification of structures or objects in said medical image data. Systems and computer-readable media for tangible implementation of the image analysis processing methods disclosed herein are presented.

### BACKGROUND

According to the United States Cancer Statistics: 2005 Incidence and Mortality report provided by the Centers for Disease Control and Prevention, colorectal cancer is the third leading cause of cancer death among men and women in the United States. The identification of suspicious polyps in the colonic lumen may be a critical first step in detecting the early signs of colon cancer. Many colon cancers may be prevented if precursor colonic polyps are detected and removed.

According to RadiologyInfo, a public information Website developed by the American College of Radiology and the Radiological Society of North America (http://www.radiologyinfo.org), an increasingly popular non-invasive medical test that may help physicians to detect colon cancer is the virtual colonography or virtual colonoscopy procedure. These tests may use various technologies such as, but not limited to, computed tomography (CT) or magnetic resonance (MR) imaging. CT colonography, for example, uses CT scanning to obtain an interior view of the colon (the large intestine) that is otherwise only seen with a more invasive procedure where an endoscope is inserted into the rectum.

In many ways, CT scanning works very much like other x-ray examinations. X-rays are a form of radiation—like light or radio waves—that can be directed at the body. Different body parts absorb the x-rays in varying degrees. In a conventional x-ray exam, a small burst of radiation is aimed at and passes through the body, recording an image on photographic film or a special image recording plate. Bones appear white on the x-ray; soft tissue shows up in shades of gray and air appears black.

With CT scanning, numerous x-ray beams may be used and, commonly, a set of electronic x-ray detectors may rotate around a patient, measuring the amount of radiation being absorbed throughout the patient's body. At the same time, the examination table may move through the scanner (or the scanner may move relative to the patient), so that the x-ray beam may follow a spiral path with respect to the patient's body. A special computer program may process the resulting large volume of data to create two-dimensional cross-sectional images of the abdomen, which may then be displayed on a monitor. This particular form of CT scanning is called helical or spiral CT. Refinements in detector technology allow new CT scanners to obtain multiple slices in a single rotation. These scanners, called “multislice CT” or “multidetector CT,” may allow thinner slices to be obtained in a shorter period of time, resulting in more detail and additional view capabilities. Modern CT scanners are so fast that they can scan through large sections of the body in just a few seconds.

For CT colonography, a computer may generate a detailed three-dimensional model of the abdomen and pelvis, which the radiologist may use to view the bowel in a way that simulates traveling down the colon. The three-dimensional model may also be processed using image processing analysis techniques to aid the radiologist in inspection of the colon. These techniques are also known as computer-aided detection or “CAD.” It has been demonstrated that physicians who utilize CAD as a “second set of eyes” may benefit significantly, either by increased sensitivity and/or by reduced interpretation time. (See, for example, “Computed tomographic colonography: assessment of radiologist performance with and without computer-aided detection,” Halligan et al., Gastroenterology, 131 (6). pp. 1690-1699.)

In the computer-assisted detection of polyps, the extent to which an image processing device such as a CAD system correctly recognizes true polyps (i.e., true positives) is often referred to as the sensitivity of the system; its ability to correctly recognize and distinguish other structures as non-polyps (i.e., true negatives) is often referred to as the specificity of the system. A false positive is a region of interest (ROI) in the virtual colonography medical image labeled by the computer as a positive, but which is later determined to be a non-polyp or true negative (by interpreter or follow-up examination such as optical colonoscopy, for example). Some studies have suggested that trying to detect and eliminate false positive sources independently could be an efficient way to increase CAD system specificity. Sources directed towards such approaches include “Reduction of false positives on the rectal tube in computer-aided detection for CT colonography”, Med. Phys. Volume 31, Issue 10, pp. 2855-2862 (October 2004); and U.S. Pat. No. 7,440,601, “Automated Identification of the Ileocecal Valve,” assigned to the United States of America as represented by the Department of Health and Human Services and the May Foundation for Medical Education and Research.

### SUMMARY

Disclosed are methods, and associated systems comprising at least one processor, at least one input device and at least one output device, for detecting regions of interest in a colonographic image, comprising: a) by means of an input device, acquiring colonographic image data; b) by means of a processor, detecting a plurality of candidate regions of interest from the colonographic image data; c) by means of a processor, for each of the plurality of candidate regions of interest, classifying said candidate region of interest into a class belonging to a set of classes comprising a first class of regions of interest for further analysis and a remainder class of regions of interest not for further analysis, wherein classification of a candidate region of interest is based upon at least one of: i) determining a likelihood that said candidate region of interest is a portion of a rectal tube, by means of (A) measuring at least one feature of said candidate region of interest, other than its overlap with said rectal tube; and (B) comparing said measured feature(s) with at least one predetermined threshold; ii) determining a likelihood that said candidate region of interest has at least one feature characteristic of stool; and iii) determining a likelihood that said candidate region of interest is a member of a cluster and is not for further analysis; and d) by means of an output device, outputting, to at least one user, information associated with at least one candidate region of interest in the first class.

In the methods and systems, the colonographic image data may be acquired by means of an image acquisition unit. The colonographic image data may comprise a colonographic volume, which may be acquired by means of an image acquisition unit obtaining a plurality of two-dimensional images of an anatomical colon, and a processor computing the colonographic volume from the plurality of two-dimensional images. The colonographic image data may be acquired from at least one of a computer network and a storage device.

The methods and systems may further comprise, by means of a processor, for each candidate region of interest in the first class, analyzing said candidate region of interest, determining a suspiciousness that said candidate region is a polyp and, based upon said suspiciousness, leaving said candidate region of interest in the first class or removing said candidate region of interest from the first class.

Determining a likelihood that said candidate region of interest is a portion of a rectal tube may further comprise determining a likelihood that said candidate region of interest overlaps the rectal tube. Measuring at least one feature of said candidate region of interest may comprise measuring at least one of a shape feature and a texture feature. Measuring a shape feature may comprise measuring at least one of a curvature and a curvedness. Measuring a texture feature may comprise measuring at least one of a range, a spread and a distribution of intensity values. Comparing said measured feature(s) with at least one predetermined threshold may comprise forming a discriminant score from a plurality of features. Forming a discriminant score from a plurality of features may comprise forming a discriminant score from at least one shape feature and at least one texture feature.

Determining a likelihood that said candidate region of interest has at least one feature characteristic of stool may comprise at least one of. c) ii) A) (I) measuring at least one feature characteristic of tagged material; and (II) comparing said measured feature(s) with at least one predetermined threshold; and c) ii) B) (I) measuring at least one air pocket feature; and (II) comparing said measured feature(s) with at least one predetermined threshold. Measuring at least one feature characteristic of tagged material may comprise measuring at least one feature characteristic of material tagged at the back side of said candidate region of interest. Measuring at least one feature characteristic of material tagged at the back side of said candidate region of interest may comprise measuring at least one intensity value of at least a portion of said back side. Comparing said measured feature(s) with at least one predetermined threshold may comprise measuring an amount of material for which an intensity value exceeds a threshold. The methods and systems may further comprise measuring at least one feature characteristic of material tagged at the front side of said candidate region of interest. Measuring at least one feature characteristic of material tagged at the front side of said candidate region of interest may comprise measuring at least one intensity value of at least a portion of said front side. Comparing said measured feature(s) with at least one predetermined threshold may comprise measuring an amount of tagged material. Measuring at least one air pocket feature may comprise measuring at least one intensity value of an interior of the candidate region of interest. Comparing said measured feature(s) with at least one predetermined threshold may comprise determining that at least a portion of the interior of the candidate region of interest has an intensity value below a surrounding region. The methods and systems may further comprise determining that said portion exceeds a predetermined size. Said predetermined size may be about 2 mm. Determining a likelihood that said candidate region of interest has at least one feature characteristic of stool may comprise determining that said measured tagged material feature(s) exceeds at least one predetermined threshold, and that said air pocket feature(s) exceeds at least one predetermined threshold.

Determining a likelihood that said candidate region of interest is a member of a cluster and is not for further analysis may comprise c) iii) A) determining that said candidate region is within a predetermined distance of at least one other candidate region, and assigning said candidate region and said at least one other candidate region within a predetermined distance thereof to the cluster; c) iii) B) determining a suspiciousness score for said candidate region; and c) iii) C) determining a likelihood that said candidate region is not for further analysis based upon its suspiciousness score. Determining a likelihood that said candidate region is not for further analysis based upon its suspiciousness score may comprise at least one of: c) iii) C) (I) comparing the suspiciousness scores of all candidate regions within the cluster and determining that said candidate region suspiciousness score is not highest; and c) iii) C) (II) comparing the suspiciousness score of said candidate region to a threshold and determining that said candidate region suspiciousness score is below the threshold. Determining a likelihood that said candidate region is not for further analysis based upon its suspiciousness score may comprise determining that said candidate region suspiciousness score is not highest; and determining that said candidate region suspiciousness score is below the threshold.

Classifying said candidate region of interest into a class belonging to a set of classes comprising a first class of regions of interest and a remainder class of regions of interest may be based upon: i) determining a likelihood that said candidate region of interest is a portion of a rectal tube, by means of (A) measuring at least one feature of said candidate region of interest, other than its overlap with said rectal tube; and (B) comparing said measured feature(s) with at least one predetermined threshold; ii) determining a likelihood that said candidate region of interest has at least one feature characteristic of stool; and iii) determining a likelihood that said candidate region of interest is a member of a cluster and is not for further analysis.

Detecting a plurality of candidate regions of interest from the colonographic image data may comprise, for each of the plurality of candidate regions of interest, analyzing said candidate region of interest and determining a suspiciousness that said candidate region is a polyp.

### BRIEF DESCRIPTION OF THE DRAWINGS

FIG. 1 is a block diagram of a representative system suitable for processing virtual colonography medical image data in accordance with an embodiment of the disclosure.

FIG. 2 is a block diagram of a system containing a plurality of classification functions, including false positive classification functions, in accordance with an embodiment of the disclosure.

FIG. 3 is a flowchart that illustrates steps that may be performed for discriminating detections on the rectal tube from candidate polyps in accordance with an embodiment of the disclosure.

FIG. 4 is a flowchart that illustrates steps that may be performed for discriminating detections on the rectal tube from candidate polyps in accordance with an embodiment of the disclosure.

FIG. 5 is a mosaic image illustrating exemplary digital representations of rectal tube portions that may be falsely detected as polyps.

FIG. 6 is a flowchart that illustrates steps that may be performed for discriminating stool from candidate polyps in accordance with an embodiment of the disclosure.

FIG. 7 is a flowchart that illustrates steps that may be performed for characterizing tagging material at predetermined locations of a region of interest (ROI) in accordance with an embodiment of the disclosure.

FIG. 8 illustrates an image slice of an exemplary ROI in which the voxels at the boundary of the segmented region characterized as the exterior perimeter of the colonic wall are highlighted.

FIG. 9 illustrates an image slice of an exemplary ROI in which tagged material backside pixels or voxels of the ROI are highlighted.

FIG. 10 illustrates an image slice of an exemplary ROI in which candidate tagged material frontside pixels or voxels of the ROI are highlighted.

FIG. 11 is a flowchart that illustrates steps that may be performed for automatically segmenting air pockets in an ROI in accordance with an embodiment of the disclosure.

FIG. 12 illustrates an image slice of an exemplary ROI in which a region extracted as the interior of the ROI is highlighted.

FIG. 13 illustrates an image slice of an exemplary ROI in which the voxels of the boundary of a single region considered to be an air pocket of the ROI are highlighted.

FIG. 14 is a flow diagram showing a cluster-based feature classification process that may be performed for discriminating non-polyps from candidate polyps in accordance with an embodiment of the disclosure.

FIG. 15 is a free-response operating curve (FROC) illustrating performance results of a cluster-based feature classification process for polyps of sizes of 6-10 mm.

FIG. 16 is a flowchart of a suspicious polyp detection and multi-level classification process that may be performed in accordance with an embodiment of the disclosure.

FIG. 17 is a block diagram of an alternate representative system suitable for the processing of virtual colonography medical image data in accordance with an embodiment of the disclosure

### DETAILED DESCRIPTION OF EMBODIMENTS

In the following detailed description of embodiments, reference is made to the accompanying drawings that form a part hereof, and in which are shown, by way of illustration and not by way of limitation, specific embodiments in which the methods and systems disclosed herein may be practiced. It is to be understood that other embodiments may be utilized and that logical, mechanical, and electrical changes may be made without departing from the scope of the methods and systems disclosed herein.

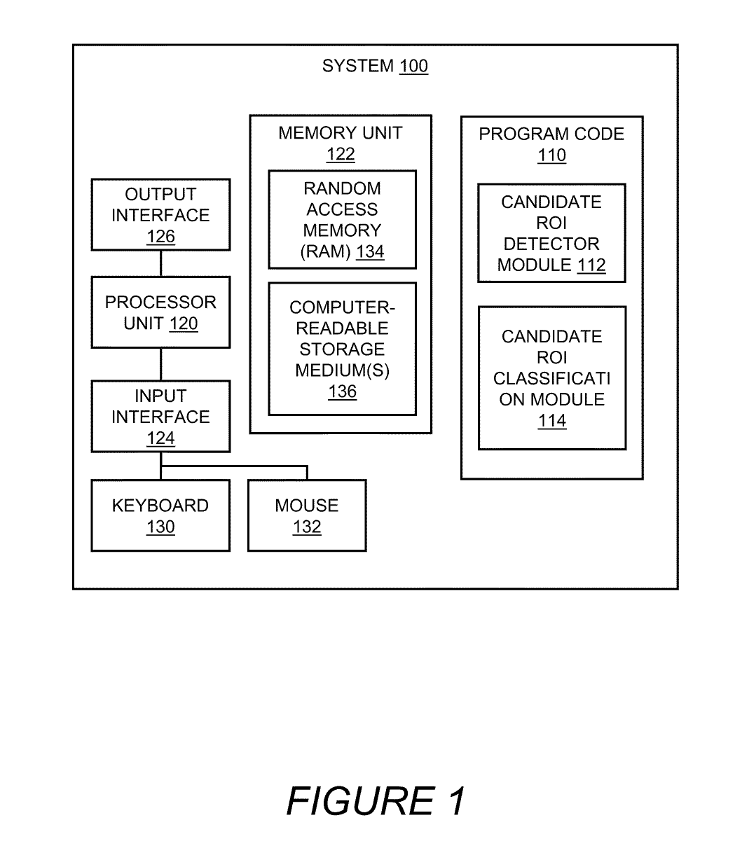

FIG. 1 illustrates a block diagram of a system 100 that may be utilized for the processing of virtual colonography medical image data in accordance with one embodiment of this disclosure. Generally speaking, system 100 is representative of a system or apparatus suitable for (1) receiving a volumetric or three-dimensional (3-D) virtual colonography medical image of the patient's colon as a series of slices and (2) processing, using combinations of hardware and software, either pixel or voxel data of the virtual colonography medical image to identify regions or features of interest. For purposes of this disclosure, when the context so requires regions may be synonymous with or represent objects, structures, anomalies, and the like. Features may be synonymous with or represent characteristics, measurements, components, descriptors, attributes, patterns, and the like. By way of a non-limiting example, each slice image in the volume may be constructed at 512×512 pixels and a spatial resolution of 0.75 millimeters x 0.75 millimeters, and the medical image volume may be comprised of a total of 300-600 slices with a spatial resolution of 1 millimeter.

System 100 may further comprise a processor unit 120, a memory unit 122, an input interface 124, and an output interface 126 (or more than one of any or all of those components). One or more input interfaces 124 may connect one or more processor units 120 to one or more input devices such as keyboards 130, mouse units 132, and/or other suitable devices as will be known to a person of skill in the art, including for example and not by way of limitation voice-activated systems. Thus, input interface(s) 124 may allow a user to communicate commands to the processor(s). One such exemplary command is the execution of program code 110 tangibly embodying image processing instructions to carry out methods set forth in this disclosure. Such input devices may also allow a user at system 100 to control an external computer system or systems. Alternatively, system 100 may itself be controlled by an input device or devices connected to an external computer system or systems. Output interface(s) 126 may further be connected to processor unit(s) 120 and an output device or devices of system 100 (not shown). Thus, output interface(s) 126 may allow system 100 to transmit data from the processor(s) to one or more output devices. For example, the virtual colonography medical imagery, or portions thereof, with or without additional information derived from analysis, may be transmitted for display to a user or users.

Memory unit(s) 122 may include conventional semiconductor random access memory (RAM) 134 or other forms of main memory known in the art; and one or more computer readable-storage mediums 136, such as hard drives, floppy drives, read/write CD-ROMs, tape drives, flash drives, optical drives, or other forms of auxiliary or secondary memory. Program code 110 may be stored on the one or more computer readable-storage medium(s) 136 and loaded into RAM 134 during execution, for example.

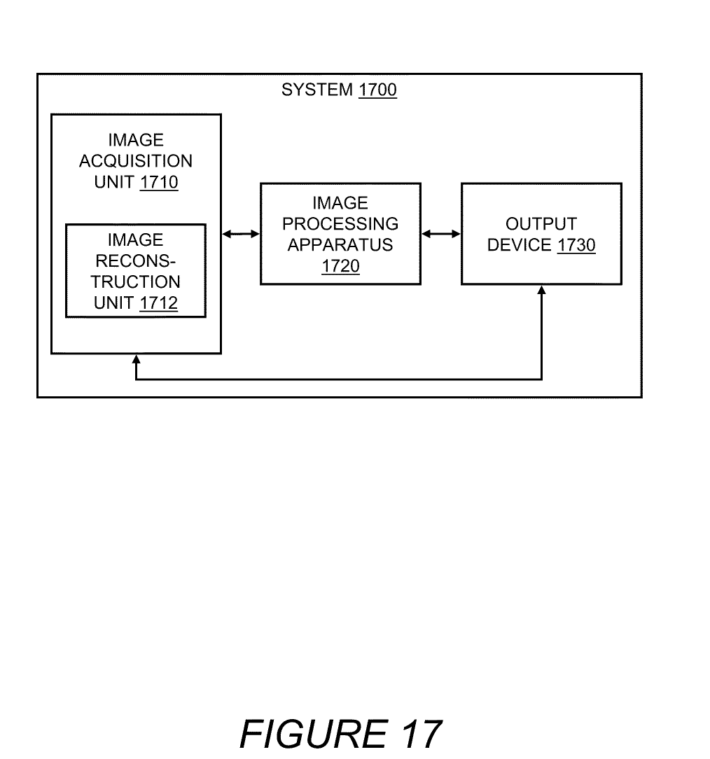

Of course, the functions of acquiring, processing, and outputting virtual colonography medical image data may be distributed amongst and performed by different exemplary sub-systems, each of which may have combinations of hardware or software. One embodiment of such a system is illustrated in FIG. 17. A description of this alternate system is presented hereinbelow. It should be recognized that the image acquisition and reconstruction may in alternative embodiments be performed by the same computer system as the image processing or and/or output, and that the image processing may be carried out by more than one computer system. So also, image data may be acquired by the image processing apparatus directly from the image acquisition and reconstruction unit(s) directly, as over a wired or wireless network, or may be transported and acquired from storage media such as a variety of portable storage media as will be known to persons of skill in the art. Thus, more generally, the methods disclosed herein may be combined in a single processor or computer system, or distributed among a plurality of processors or computer systems.

In system 100, program code 110 is stored in memory and, when retrieved from memory and executed, causes system 100 to perform various image processing functions on virtual colonography medical images. Program code 110 may contain a candidate region of interest (ROI) detector module 112 for detecting and (optionally) segmenting individual ROIs from the virtual colonography medical imagery, and a candidate ROI classification module 114 for computing and assigning classification information for individual ROIs. Generally speaking, the goal of candidate ROI detector module 112 is to detect true polyps at an extremely high sensitivity. In doing so, many non-polyps may also be detected. (Of course, the actual number of non-polyps detected in a given image may vary, depending on factors such as, but not necessarily limited to, thresholds used by a detector module and/or the preparation of the colon.) The goal of candidate ROI classification module 114 is to discriminate among individual ROIs identified by candidate ROI detector module 112, so as to identify true regions or features of interest with the highest accuracy.

Candidate ROIs detected by candidate ROI detector module 112 are often referred to as “candidate polyps,” “suspicious polyps”, “candidate detections”, or variations thereof. By way of one non-limiting example, candidate ROI detector module 112 may identify candidate ROIs based on characteristics relating to expected geometric features (e.g., Gaussian curvature, elliptical curvature, sphericity, size) and/or based on texture features (e.g., intensity statistics) of the ROI. Generally speaking, polyps are expected to be relatively round, homogeneously intense soft tissue of a particular size (e.g., 6-10 millimeters). One suitable technique for identifying candidate ROIs can be seen in U.S. Pat. No. 7,236,620, “Computer-aided detection methods in volumetric imagery,” which is incorporated herein by reference. In that patent, candidate ROIs are identified within an image mask representing the segmented colon using spherical summation techniques. This example is presented merely as illustrative of one approach and not by way of limitation; other techniques as will be known to persons of skill in the art may be used to detect candidate ROIs exhibiting characteristics of polyps.

Following detection, a segmentation of individual candidate ROIs may be performed that improves or refines the grouping of pixels or voxels identifying each candidate. Two exemplary suitable segmentation algorithms are active contours or deformable surfaces. See, for example, “3D colonic polyp segmentation using dynamic deformable surfaces,” Yao et al., Medical Imaging 2004: Proceedings of the SPIE, Volume 5369, pp. 280-289 (2004). However, other techniques known to persons of skill in the art may be used alternatively or in combination with one or both of these techniques.

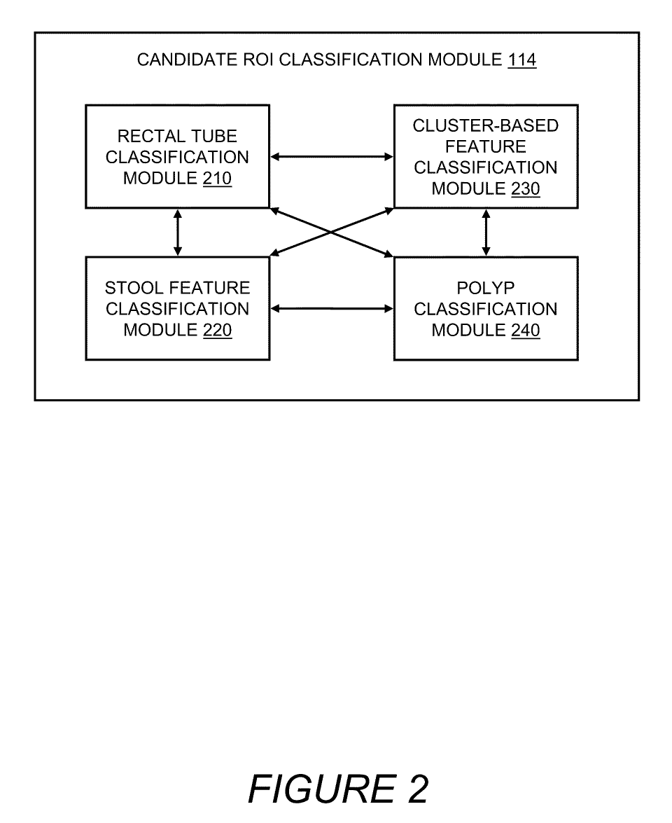

FIG. 2 illustrates an embodiment of a candidate ROI classification module 114 in which a rectal tube classification module 210, a stool feature classification module 220, a cluster-based feature classification module 230, and a polyp classification module 240 are used. Connections between blocks in FIG. 2 are displayed to indicate that computed information, such as labels, probabilities, features of interest, or other classification outcomes, may be transmitted between the modules. All four classification modules shown in FIG. 2 do not need to be implemented as part of candidate ROI classification module 114. A fewer number of these modules may be implemented, and indeed other modules may also be used in addition to those shown in FIG. 2. However, because each module shown in FIG. 2 may contribute to the overall classification of polyps from non-polyps, an embodiment of candidate ROI classification module 114 described herein contains and executes the four classification modules. Each classification module will be briefly introduced.

Rectal tube classification module 210, stool feature classification module 220, and cluster-based feature classification module 230 each exploit different feature characteristics of non-polyps as means to correctly identify or discriminate potential regions or features of interest as such. More generally, these classification modules which seek to detect classes of non-polyps may be collectively referred to as false positive or “FP” modules; as noted above, other FP modules may be used in addition to those explicitly shown in FIG. 2.

FP modules may present several advantages in the computer-aided classification of polyps in virtual colonography medical image data. Firstly, in accordance with the goal of candidate ROI classification module 114 presented hereinabove, FP modules may identify and eliminate specific and predictable classes of false positives with little to no misclassification of true polyps (i.e., few or no false negatives). FP modules may also serve to reduce the number of candidate ROIs that must be considered in subsequent, more computationally intensive, classification stages. This may reduce the overall image processing time, which may be of critical importance in commercial use, especially in light of the large amounts of image data generated using virtual colonography imaging technology. FP modules may further enable adjunct classification stages to exploit unique characteristics of polyps that would otherwise be undiscoverable or unexploitable, because certain classes of non-polyps may mimic such characteristics. Thus, the sensitivity with which true polyps are recognized may be improved if non-polyp confusors can be eliminated first by FP modules. Polyp classification module 240 is an example of a classification module that is computationally intensive and may benefit from sensitivity improvements in light of the exclusion of classes of non-polyps by FP modules, as well as from a reduction in processing time due to the same factor. These advantages will be explored in greater detail hereinbelow.

During a virtual colonography imaging procedure, a rectal tube may be placed in the patient for insufflation of the patient's colon with air or carbon dioxide. Since the rectal tube is a cylindrical shaft with a bulbous tip that has a shape similar to that of many polyps, the rectal tube (or portions of it) may be falsely detected as a polyp. Rectal tube classification module 210 may exploit characteristics of rectal tubes to identify detections on the rectal tube so that they may be correctly identified as non-polyps.

In one embodiment of the disclosure, rectal tube feature classification module 210 identifies detections on the rectal tube by measuring image-based features of candidate ROIs and comparing these measurements against thresholds derived from exemplary digital representations of rectal tubes. (Such exemplary representations are often referred to in the art of pattern recognition and classification as a “training set.”) This technique for identifying detections on the rectal tube will be henceforth referred to as ROI feature-based classification.

In another embodiment of the disclosure, rectal tube feature classification module 210 identifies detections on the rectal tube by supplementing an ROI feature-based technique with a rectal tube segmentation overlap technique. Using the rectal tube segmentation overlap technique, detections on the rectal tube are identified based on measurements which determine that there is overlap between the location of a candidate ROI detected/segmented from the image and the location of the rectal tube object segmented from the image. The rectal tube object segmentation may be carried out using handcrafted, expert rules. These rules are intended to partition the colonic region in which the rectal tube is placed as accurately as possible into (1) rectal tube (foreground pixels or voxels) and (2) non-rectal tube (background pixels or voxels). In this embodiment, the two approaches (ROI feature-based classification and rectal tube overlap) are complimentary yet distinct; it has been found through experimentation that using both techniques results in the identification of a higher percentage of detections on the rectal tube than a single technique alone. Embodiments of rectal tube feature classification module 210 will be further described hereinbelow.

Stool feature classification module 220 may exploit unique feature characteristics of stool so as to identify ROIs as such. Colonic polyps and colonic stool may share similar characteristics in that they are often both adjacent to the colonic wall and they often exhibit similar sizes, shapes, and soft tissue intensities. While in the past colonic residue has been physically cleansed from the bowel, there is an increasing desire to obviate the need for this procedure. Today, patients may consume an agent that tags the fecal contents of the bowel, causing the colonic residue to exhibit a high intensity when imaged. Unfortunately, in many cases, colonic stool may poorly absorb or fail to absorb the tagging agent altogether. This could occur, for example, if the tagging agent has not completely worked through the bowel, if the patient fails to consume the recommended dose of tagging agent, or if a large amount of stool relative to the administered dose is present in the colon. Variability in the effectiveness of different tagging agents may be yet another reason for poor fecal tagging. Therefore, stool may appear either heterogeneous or homogeneous in appearance.

In one embodiment of the disclosure, stool feature classification module 220 may classify ROIs on the basis of either tagging material features or air pocket features. Tagging material may be characterized as contents of the bowel (e.g., stool, residue, fluid, or combinations thereof) that have been tagged through consumption of a tagging agent (such as barium sulfate and/or iodinated liquids). As will be further discussed hereinbelow, tagging material features may enable discrimination between different classes of colonic anomalies when appearing at certain predetermined locations. An air pocket, which may also be considered a depression, an air bubble, or a hole, may reduce the solidity of the structure; heterogeneous stool may be non-solid. An air pocket may be characterized by a region dark in intensity relative to a surrounding region of a colonic ROI, since the x-rays reaching the air pocket pass without attenuation through the region. In contrast, the surrounding region appears lighter in intensity relative to the air pocket, since the x-rays are absorbed by the surrounding region. Air pocket features may also enable discrimination between different classes of colonic anomalies.

In an embodiment of the disclosure, stool feature classification module 220 may analyze both tagging material and air pocket features; this has been found through experimentation to result in a higher sensitivity with which stool may be recognized than a single feature alone. However, both features do not need be analyzed, and either feature alone may be of use in identifying stool. For example, although it has been found that some heterogeneous stool may exhibit both features, it has also been found that some homogeneous stool may exhibit only the tagged material features. Embodiments of stool feature classification module 220 will be further described hereinbelow.

Cluster-based feature classification module 230 applies image feature-based classification logic to only those candidate ROIs that appear in clusters or groups. This logic models the understanding that false polyps, particularly stool and poorly distended colonic tissue detections of sizes 6-10 mm, will cluster or group together more frequently than true polyps. Poor colonic distention and poor preparation are two causes for such clustering behaviors. The classification logic also accounts for the possibility that true polyps may appear among clusters or groups of detections. Embodiments of cluster-based feature classification module 230 will be further described hereinbelow.

In certain embodiments, it may be desirable for system 100 or its user or users to control the output of suspicious findings by appropriate selection of a system operating point and/or one or more suspiciousness probabilities to be associated with individual candidate ROIs displayed in a given image or otherwise output. For example, a polyp suspiciousness threshold may be set based on the system operating point and only those candidate polyps with probabilities above the threshold may be output as suspicious polyps. Polyp suspiciousness probabilities may be computed through classification of each candidate ROI. However, the exemplary FP classification modules described herein are not necessarily designed to characterize polyp suspiciousness. Therefore, polyp classification module 240 is included in the FIG. 2 embodiment of candidate ROI classification module 114 as a means for characterizing polyp suspiciousness. In one embodiment, polyp classification module 240 may characterize polyp suspiciousness after one or more FP classification modules classify at least some candidate ROIs with respect to feature characteristics as described hereinabove into a class for further analysis. Embodiments of polyp classification module 240 will be further described hereinbelow. The use of polyp classification module 240 or other polyp classification schemes allows the system to take advantage of the prior elimination of true negatives among candidates to refine the discrimination of true polyps (true positives) among remaining candidates. However, while in the embodiment described hereinbelow polyp classification module 240 is executed after the FP classification modules, to take advantage of this opportunity, it may optionally be executed at any stage in the process, including before the FP classification modules, or between FP classification modules, and the FP classification modules may be executed in orders different than that described herein.

### Exemplary Rectal Tube Classification Methods

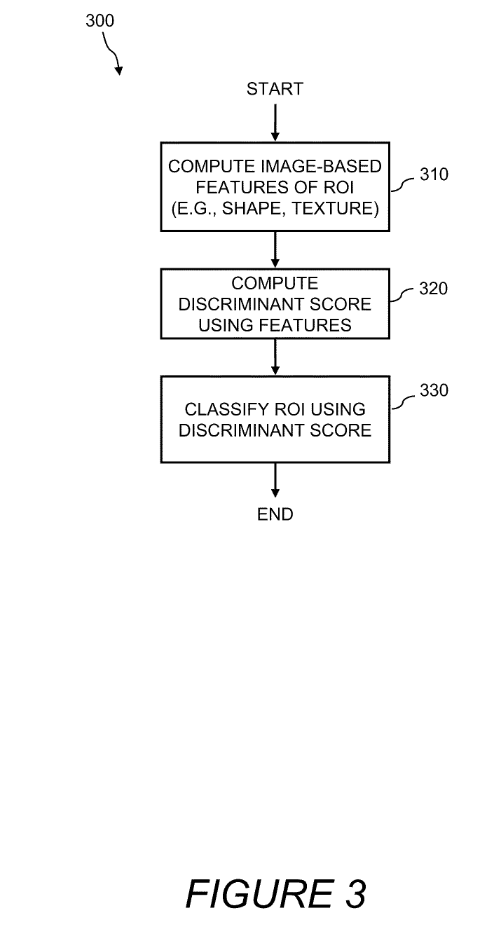

FIG. 3 illustrates steps that may be performed by one embodiment of rectal tube feature classification module 210 in accordance with an ROI feature-based classification technique for discriminating detections on the rectal tube.

At step 310, the values of image-based features selected from a training procedure are computed for a candidate ROI under evaluation. The image-based features may characterize both the shape and the texture of the candidate, although alternatively either shape or texture features may be used without the other, or other features than shape or texture may be used, either alone or in combination with shape and/or texture features. These exemplary features for characterization may be selected based on a training set of digital representations of rectal tubes and with the assistance of a feature selection process. By way of one example, a suitable training set may be established by identifying a set of candidate suspicious polyps on a training set of virtual colonography images and labeling as true positives those detections on the rectal tube. All other candidate suspicious polyps that do not overlap the rectal tube may therefore be considered as false positives (i.e., non-rectal tube detections). Labeling as to overlap versus non-overlap may be determined manually by a human observer skilled at identifying the rectal tube from the medical imagery, or by appropriate automatic techniques. From such a training set, image-based features common to rectal tubes may then be selected by applying a feature selection process or other suitable attribute/variable selection technique to features of the training set. A feature selection process selects a subset of relevant features for building a learning model. One example of a suitable feature selection process is a greedy algorithm (e.g., forward selection, backward elimination, etc.), but other techniques may be used. This selection process may be executed using any suitable system and may be accomplished at a substantially different time than the processing of the virtual colonography medical image for which detection and classification of suspicious polyps may be desired. While both shape and texture features have been identified as being of utility, as noted above other image-based features could be derived by way of such a process, and could be used in addition to or as an alternative to shape and texture features.

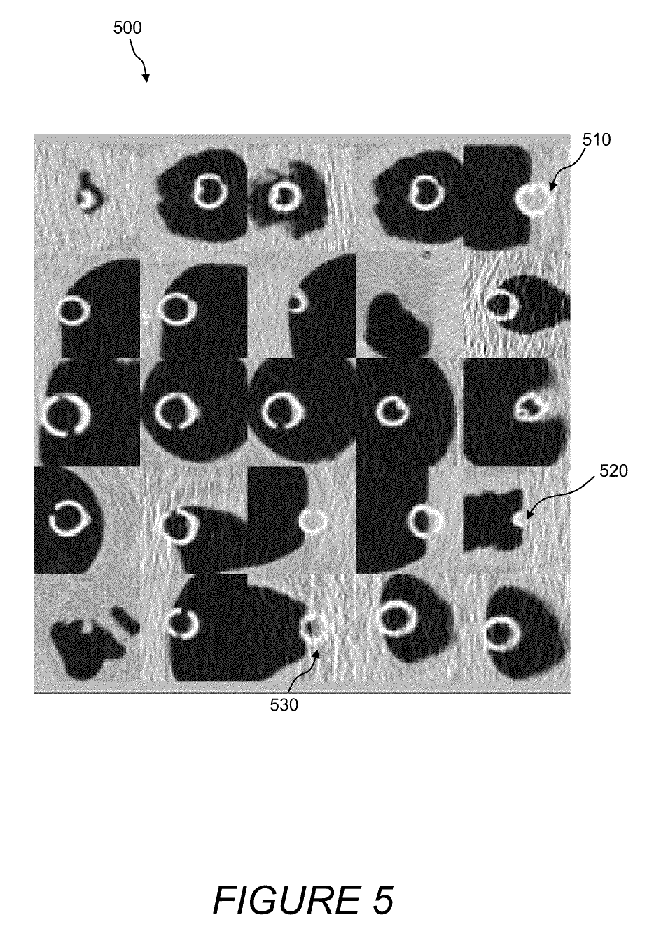

In some cases, the center of the rectal tube detection will contain air and because these pixels or voxels will be extremely dark, a candidate detection or segmentation step as described hereinabove may fail to detect the center as part of the region of interest. In other cases, the rectal tube detection will contain no air. Such rectal tube detections therefore may be wholly or substantially wholly on an artificial surface; they would therefore be expected to be more homogeneous than soft tissue such as polyps. However, in other cases, the center of the rectal tube detection could contain fluid instead of air, which could cause the rectal tube detection to exhibit more heterogeneity than many soft tissues such as polyps. Various examples of rectal tube detections are illustrated in FIG. 5 and specific examples shown in this FIG. 5 will be discussed hereinbelow.

Computing a statistic that measures the texture of each detected anomaly allows for the characterization of homogeneity/heterogeneity. One means for characterizing texture involves characterizing the range, distribution, or spread of intensity values. The range or spread of intensity values for detections on the rectal tube may be expected to be either statistically smaller or statistically larger than the spread of intensity values for non-rectal tube detections. The standard deviation of the intensity values of the candidate has been found to usefully model such characteristics and may be computed for feature-based classification of rectal tubes. A suitable computation for such a feature is:

$$\sqrt{\frac{{\sum }_{x ∈ S} {I ( x )}^{2} - N * {μ}^{2}}{N - 1}}$$

where
S is the candidate segmentation,
N is the number of points in the segmentation,
μ is the mean of the intensity in the segmentation, and
I(x) is the intensity at a given candidate pixel or voxel x.

Detections that are on the rectal tube may also be characterized in that the cylindrical shape of a rectal tube is substantially different from the shape of non-rectal tube detections. One means for characterizing shape involves computing curvature and/or curvedness features of the anomaly. The use of both features in combination may have higher rectal tube discrimination power, since rectal tube detections are typically a curved surface having convexity, but may be complicated by the fact that they may have both a convex (outside) surface and a concave (inside) surface. These shape properties may be modeled by positive amounts of curvature on one side and negative curvature on another. A maximum curvature feature may usefully model convexity and a median curvedness feature may usefully model cylindrical shape properties for feature-based classification of rectal tubes. A suitable computation for a maximum curvature feature is:

$${max}_{x ∈ S} H ( x ) + \sqrt{{H ( x )}^{2} - K ( x )}$$

where
S is the candidate surface,
K(x) is the Gaussian curvature at a given candidate pixel or voxel x, and
H(x) is the mean curvature at x.
A suitable computation for a median curvedness feature is: median over all pixels or voxels x in the candidate surface of

$$\sqrt{\frac{{m ( x )}^{2} + {M ( x )}^{2}}{2}}$$

where
m(x) is the minimum principal curvature at a given candidate pixel or voxel x and
M(x) is the maximum principal curvature at x.
The maximum principal curvature M(x) is, as given above is:

$${max}_{x ∈ S} H ( x ) + \sqrt{{H ( x )}^{2} - K ( x )}$$

and the minimum principal curvature m(x) is:

$${min}_{x ∈ S} H ( x ) + \sqrt{{H ( x )}^{2} - K ( x )}$$

Of course, other equations may be used in addition to or in place of these.

At step 320, a discriminant score may be formed using the computed values of the candidate's features. A discriminant score acts as a measure of suspiciousness in a multi-dimensional feature space. In an embodiment, the discriminant score may be a multi-dimensional measure that characterizes the texture and the shape of the candidate ROI (e.g., the intensity, curvature, and curvedness feature values) as described hereinabove, although alternate features and/or additional features could be used. A suitable discriminant score may be computed using a quadratic statistical classifier, which is one form of machine learning algorithm known in the art. The use of a quadratic classifier is not required, however. It is merely one classification algorithm that may be employed in accordance with this disclosure. A wide range of other classifiers are alternatively available, as will be known to persons of skill in the art.

A quadratic statistical classifier computes a discriminant score based on both a mean statistic and a variance statistic derived from features for which a class label is desired, using a training set of previously labeled items. For example, the discriminant score may be computed based on the distance (in image-based feature space) from the intensity, curvature, and curvedness features of the candidate ROI to intensity, curvature, and curvedness features of the training set, taking both mean and variance data for intensity, curvature, and curvedness features into account. The discriminant score may be expressed, for example, as a difference between the class discriminants and computed features in feature space and could be normalized (e.g., to a 0 to 1 scale). The result of this process is often termed a “suspiciousness score.”

At step 330, the candidate ROI may be classified using the discriminant score. The discriminant score may be compared against a predetermined threshold acting as a boundary between class decisions; the boundary or threshold may be chosen based on the training set. In accordance with an embodiment, there may be only a hard or “yes/no” classification decision output from the comparison, based on whether the computed score exceeds or falls short of the threshold. For example, if the discriminant score exceeds the predetermined threshold by any amount, the candidate ROI may be classified as part of the rectal tube (and thus, a non-polyp); otherwise, the candidate ROI is not classified as part of the rectal tube. In other embodiments, soft classification decisions such as probabilities based on distance differences between discriminant scores and thresholds may be output, and these soft probabilities may be used in combination with other analyses to classify or report on the ROI.

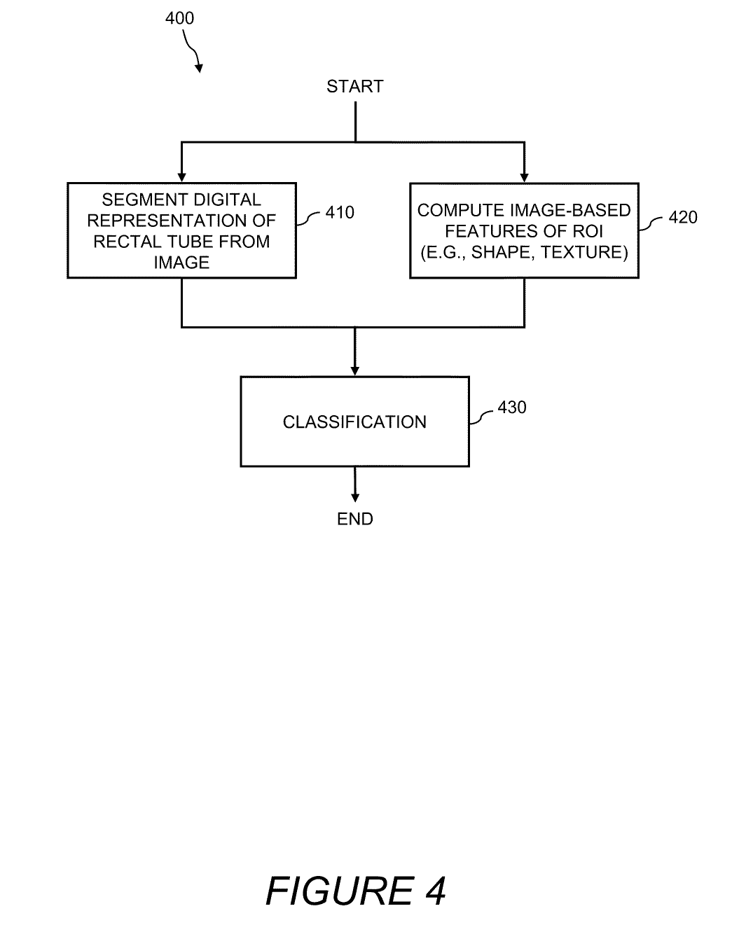

FIG. 4 presents steps that may be performed by an embodiment of rectal tube feature classification module 210 in accordance with both an ROI feature-based classification technique and a rectal tube segmentation overlap technique for discriminating detections on the rectal tube.

At step 410, a representation of the rectal tube is segmented from the virtual colonography medical image. One technique for rectal tube image segmentation processing involves computing a radial response. Generally speaking, radial response functions identify low intensity regions that are radially symmetric; that is, the objects identified are relatively circular in shape and have converging gradients towards their center. One publication describing the application of radial response point detection in imagery is “Fast radial symmetry for detecting points of interest,” Loy et al., IEEE Pattern Analysis and Machine Intelligence, Vol. 25, No. 8, August 2003, pp 959-973. However, radial response functions are merely one example of rectal tube image segmentation processing methods that may be performed. Other suitable techniques instead of or in addition to the use of radial response functions include, for example, template matching, mathematical morphology, or region-based segmentation.

At step 420, the values of ROI features useful in characterizing detections on the rectal tube, such as shape and texture features, are computed, as described hereinabove. Steps 410 and 420 may be performed in either order, or in parallel.

At step 430, the candidate ROI under evaluation is classified using both the rectal tube segmentation results and the computed values of the image-based features. In an embodiment, a hard or “yes/no” classification decision may be accomplished by independently evaluating the two sets of results in a serial process. In other words, a candidate ROI may be classified as a detection on the rectal tube if the information satisfies either of two conditions: (1) the candidate ROI overlaps a minimum number of pixels or voxels of the segmented rectal tube; or (2) a discriminant score formed from the computed values of the image-based features of the candidate ROI exceeds a predetermined threshold. (Alternatively, a candidate ROI may be classified as a detection on the rectal tube if the information satisfies both of the two conditions, in which case either or both parametric classification conditions may be adjusted accordingly.) Alternatively to the arrangement in FIG. 4, the classification of the candidate ROI as a detection on the rectal tube may be performed prior to the computation of image-based features, or the classification of the candidate ROI based on image-based features may be performed prior to the segmentation of the rectal tube. In both of these cases, of course, if the initial determination is that the candidate ROI is a false positive, the second rectal tube classification technique need not be performed.

Candidate ROI-rectal tube overlap may be measured by overlaying a mask of segmented rectal tube regions on a mask of candidate ROI detections and then comparing overlap between the pixels or voxels of regions of interest in both masks. Assuming that true polyps will rarely (if ever) appear on the rectal tube, those candidate ROIs in the mask having any overlap with the rectal tube (i.e., a minimum of at least one pixel or voxel) may be classified as part of the rectal tube.

Alternatively, classification may be accomplished by jointly evaluating the two sets of information. For example, a discriminant score may be formed based on information regarding both rectal tube overlap and the values of computed features of the candidate ROI.

Discrimination by use of both an ROI feature-based classification technique and a rectal tube segmentation overlap technique has been found to increase the total number of false detections on the rectal tube that may be eliminated. In one experiment using the embodiment presented with reference to FIG. 4, where the two techniques were implemented serially, and an ROI was classified as a non-polyp if it was identified as a detection on the rectal tube by either technique, a 3.62% reduction in the total number of false positives was achieved with no reduction or loss in sensitivity of true polyp detection.

The ROI feature-based classification technique alone was executed over numerous series of candidate ROI detections. A 1.53% reduction in the total number of detections on the rectal tube was achieved with no reduction or loss in sensitivity of true polyp detection. Numerous detections on the rectal tube that were discriminated by the ROI feature-based classification technique were not discriminated by the rectal tube segmentation overlap technique. Upon further inspection of this problem, it was recognized that the intensity, appearance, shape, cross-sectional area, or other characteristics of a rectal tube could vary depending on the particular type being used in practice. This leads to potential problems with handcrafted, expert rules for segmenting rectal tubes from the image. To illustrate the point, FIG. 5 presents a mosaic image of exemplary digital representations of rectal tubes that exhibit characteristics of potential polyps. Sub-image 510 shows a cross-section of a rectal tube filled with fluid instead of air, which could pose problems for image segmentation algorithms that rely on the presence of air for rectal tube identification. Sub-image 520 shows a cross-section of a rectal tube that is closed and appears like a bump on the colon wall, which could also pose problems for image segmentation algorithms that rely on the presence of substantial openness or circularity for rectal tube identification. Another factor that could impact segmentation of a rectal tube is the amount of noise in the image. Sub-image 530 shows a cross-section of a rectal tube in which many soft tissue pixels have high intensity values like the rectal tube due to image noise, which could also pose problems for image segmentation algorithms that rely on the presence of distinct intensity values for rectal tube identification. These polyp-like regions were correctly discriminated as non-polyps on the basis of the suspiciousness of their image-based features, not their overlap with a segmentation of the suspected rectal tube.

### Exemplary Stool Feature Classification Methods

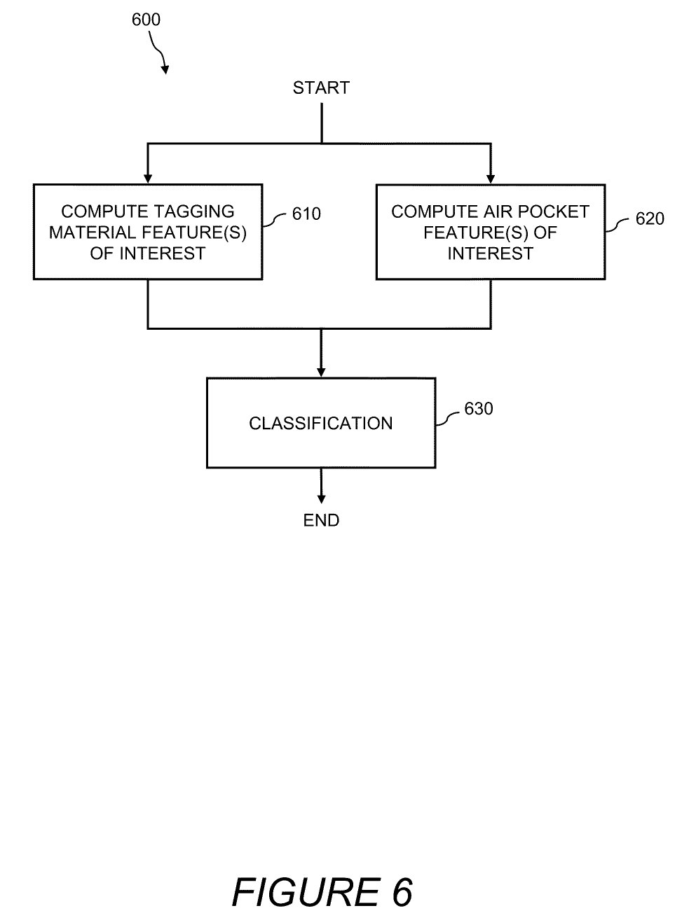

Now turning to FIG. 6, that figure presents steps that may be performed by an embodiment of stool feature classification module 220. In the embodiment of FIG. 6, both tagging material and air pocket features of interest are analyzed, but it will be recognized that either approach may be used independent of the other.

### Exemplary Tagged Material Feature Detection Methods

At step 610, a tagging material feature or features of interest are computed for a candidate ROI under evaluation. In one embodiment, tagging material is identified at predetermined locations of interest of the candidate ROI under evaluation. One predetermined location of interest that may contain tagging material is the backside of an ROI, defined as the location at which an ROI meets the exterior perimeter of the colon mask (including, but not limited to, folded portions or “folds” of the colon). This location represents an interface between the ROI and the colon wall facing the colon lumen. This interface may be expected to be homogeneous with both the ROI and the colon wall if the ROI grows from the colon wall, as in the case of polyps. However, tagging material may appear at such a location because, unlike polyps, colonic stool does not grow from the colonic wall and tagging material may adhere between the stool and the wall. Since the tagging material is bright, the interface would be heterogeneous with respect to the ROI and colon wall.

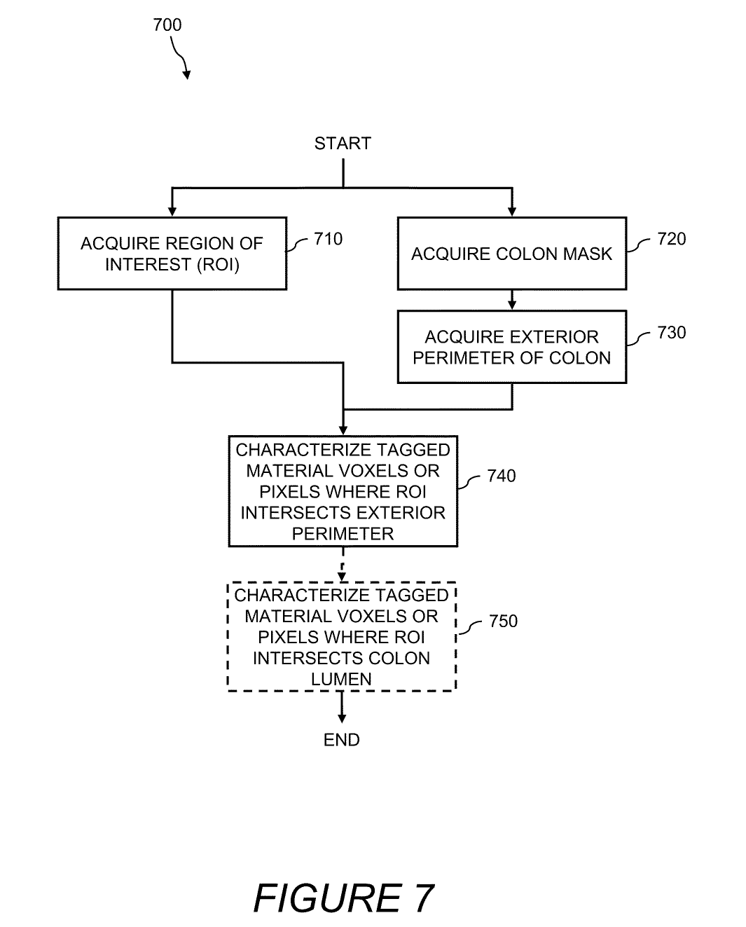

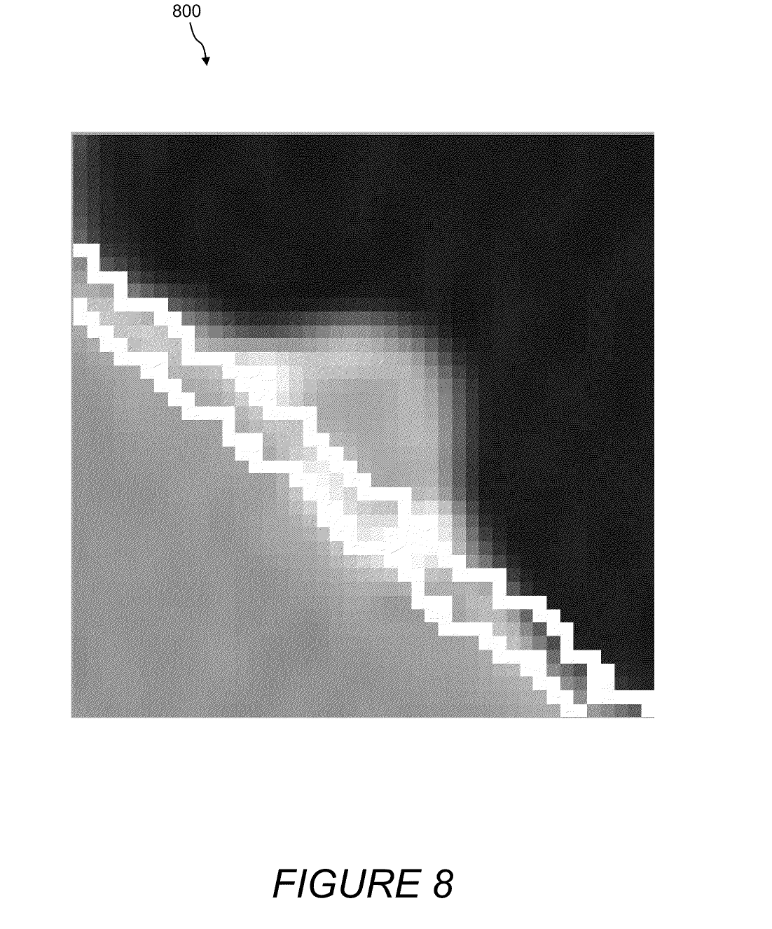

An exemplary embodiment of a method for detecting tagged material at this location is described with reference to FIG. 7. An image mask of a ROI and an image mask of the colon, which may be computed or may be received from a memory or another processor which has processed the virtual colonography image, are input for this method. These image masks are received at steps 710 and 720, respectively. Embodiments for acquiring the ROI image mask by processing have been described hereinabove with reference to candidate ROI detector module 112. The colon image mask may be segmented automatically from the virtual colonography medical imagery using image processing techniques known in the art. These techniques are often referred to as colon segmentation algorithms. One example is a convex hull algorithm, as described in pending U.S. patent application Ser. No. 12/362,111, “COMPUTER-AIDED DETECTION OF FOLDS IN MEDICAL IMAGERY OF THE COLON,” incorporated herein in its entirety. Other techniques known to persons of skill in the art alternatively or in addition to this technique could be used for deriving a representation of the colon. From a colon mask, a representation of the outer perimeter of the colon, namely the surface of the colon that faces the hollow portion (i.e., interior or lumen) of the colon, may then be acquired at step 730. In one embodiment, the 6-connected perimeter of the colon mask may be processed to derive a representation of the area. Another exemplary technique may include eroding the colon mask, which leaves a representation of the perimeter. Again, other techniques known to persons of skill in the art may be used alternatively or in addition to that technique. While step 730 necessarily must follow step 720, those two steps may be performed before, after, or in parallel with, step 710. For illustrative purposes, FIG. 8 shows an image slice 800 of an ROI in which the voxels of the 6-connected perimeter of the colon mask are circumscribed in white.

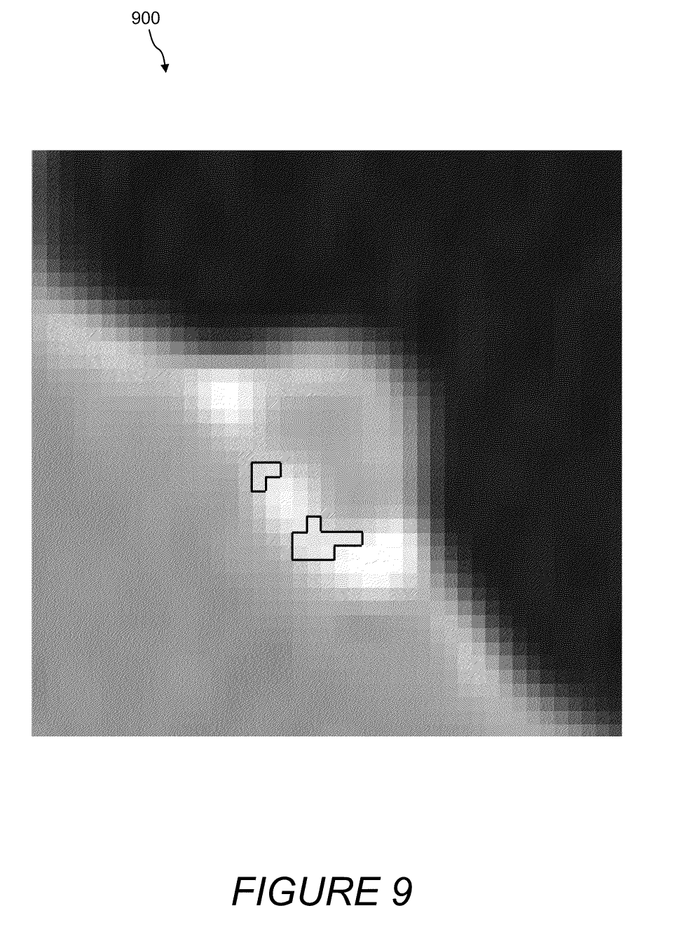

By evaluating this location, candidate backside pixels or voxels at which the tagging agent might adhere between the colon wall and the candidate ROI can then be analyzed at step 740. Since tagging agent and tagged material exhibit high intensity values relative to the soft tissue colon, the individual pixels or voxels that meet a parametric characteristic (i.e., exceed an intensity threshold) may be segmented as part of the feature. For example, the threshold may be an intensity value of approximately 300 Hounsfield Units (HU) when CT imaging technology is used. Alternatively, to account for tagging agent intensity variability, which may occur as a result of preparation variability (e.g., type of agent administered) and/or tagging agent absorption, a dynamic parametric intensity characteristic may be determined and used on an image-by-image basis. For example, the type of administered contrast agent could be retrieved from the header file of the virtual colonography image data and a lookup table could be used to derive suitable intensity ranges for the agent, and/or an intensity histogram could be created from pixels or voxels of the colonic region and the parametric intensity characteristic could be derived from approximately the upper 10% of intensity values, which typically represent the tagged material in the colon. For illustrative purposes, FIG. 9 shows an image slice 900 of the ROI illustrated in FIG. 8, in which tagging agent backside pixels or voxels of the ROI are circumscribed in white. It may be noted that certain high intensity pixels visible on FIG. 9 that might be indicative of tagging agent were not identified in this step because they previously were eliminated from the segmentation of the candidate ROI. This was done so that such pixels did not confuse feature statistics gathered from the ROI itself (for use by cluster-based feature classification module 120 and/or polyp classification module 122, for example) in which the tagging agent is undesirable. Prior to step 740, one might in another embodiment re-capture those pixels for purposes of the tagging agent feature classification.

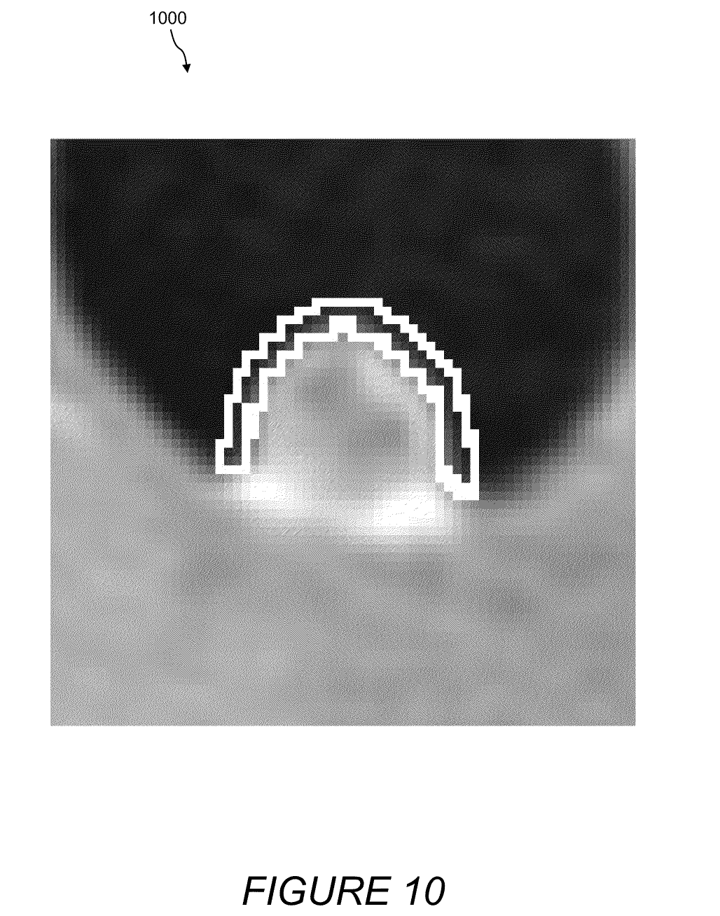

Another location of interest that may contain tagging material is the frontside of the ROI, which may be defined as the perimeter or surface pixels or voxels of the ROI that do not touch the exterior perimeter of the colon mask (i.e., the interior surface wall of the colon), and instead meet or intersect the interior volume or lumen of the colon. Detecting the presence of tagging agent on this frontside may be another way to determine if the ROI is stool, since ROIs which are stool may have the ability to absorb or retain tagging agent or tagged material on their frontside. As an optional step, perimeter pixels or voxels that may show the presence of tagging material on the frontside of the ROI may be gathered and analyzed at step 750. Techniques for characterizing tagging agent as described hereinabove may be utilized. For illustrative purposes, FIG. 10 shows an image slice 1000 of the ROI illustrated in FIGS. 8 and 9 in which candidate tagging agent frontside voxels of the ROI are circumscribed in white. It should be noted that in FIG. 10 none of the voxels so identified contain tagging agent.

### Exemplary Air Pocket Feature Detection Methods

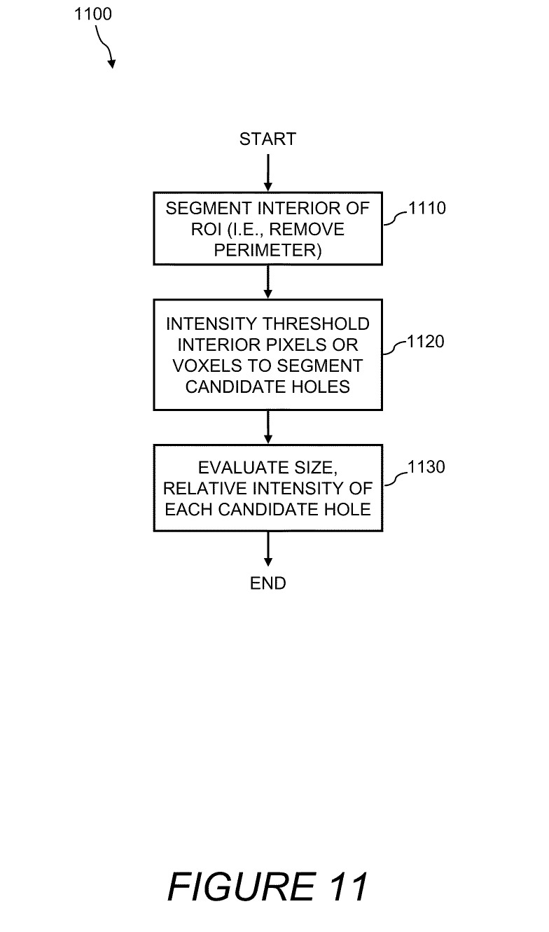

Again referencing FIG. 6, at step 620, an air pocket feature or features may be computed for a candidate ROI under evaluation. An exemplary embodiment of a method for detecting air pocket features within an ROI is illustrated with reference to FIG. 11. In this method, an air pocket feature is identified as a sufficiently sized region of lower intensity pixels or voxels located in the interior of the ROI.

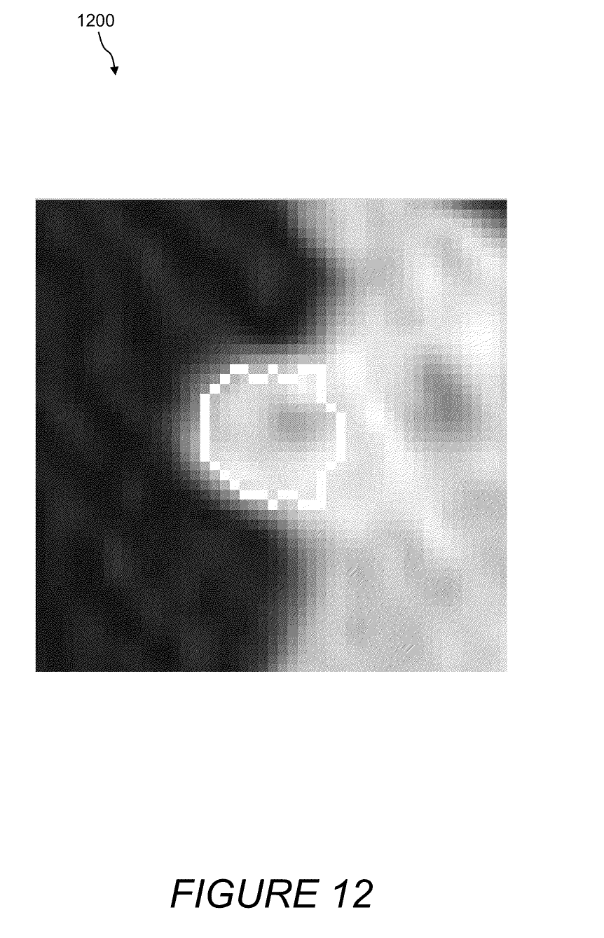

FIG. 11 illustrates one means for detecting air pockets with such characteristics. In this method, an interior region of the ROI in which an air pocket feature may be located is first segmented at step 1110. Only the interior of an ROI should be examined for an air pocket feature, because the perimeter of an ROI will typically contain partial volume effects that are dark, but not actually air pockets or holes in the structure. Partial volume effects may occur during imaging as a result of the decreasing thickness of an anomaly at its edge. One skilled in the art will appreciate that there are numerous image processing techniques for finding the interior of an object at step 1110. For example, three-dimensional connectivity using a 6-connected neighborhood of scalar values may be utilized. Other techniques that could be used for finding the interior by reducing the perimeter include morphological erosion operations, which reduce a number of pixels or voxels from the ROI using a kernel size and object shape; distance transform methods, which may identify pixels or voxels that are a set distance from either off-ROI or centroid-ROI pixels or voxels; or active contour iso-level thresholding, which eliminates low intensity pixels or voxels on the perimeter by thresholding on energy values derived from an active contour segmentation algorithm. Multiple image processing techniques, including those identified above or others known to persons of skill in the art, may be used together or serially to identify the interior region of the ROI where a more conservative detection scheme may be desired to minimize mischaracterizations. For illustrative purposes, FIG. 12 shows an image slice 1200 of an ROI in which a boundary around a region considered to be the interior of the ROI is highlighted.

Again referencing FIG. 11, the interior region of the ROI may then be thresholded to identify low intensity pixels or voxels for consideration as part of a candidate air pocket at step 1120. Any interior pixels or voxels having intensity values between −700 and −175 Hounsfield Units (HU) may be air pocket feature candidates. A narrower intensity threshold (e.g., between −700 and −400 HU) may be used if, for example, a more conservative technique is used to identify the interior of the object at step 1110. Such intensity measurements generally model what can be observed about the intensity values of true air pockets in colonic stool. However, these parameters were optimized over one set of examples and therefore other parameters or ranges of parameters could be used without departing from this technique to detect air pockets.

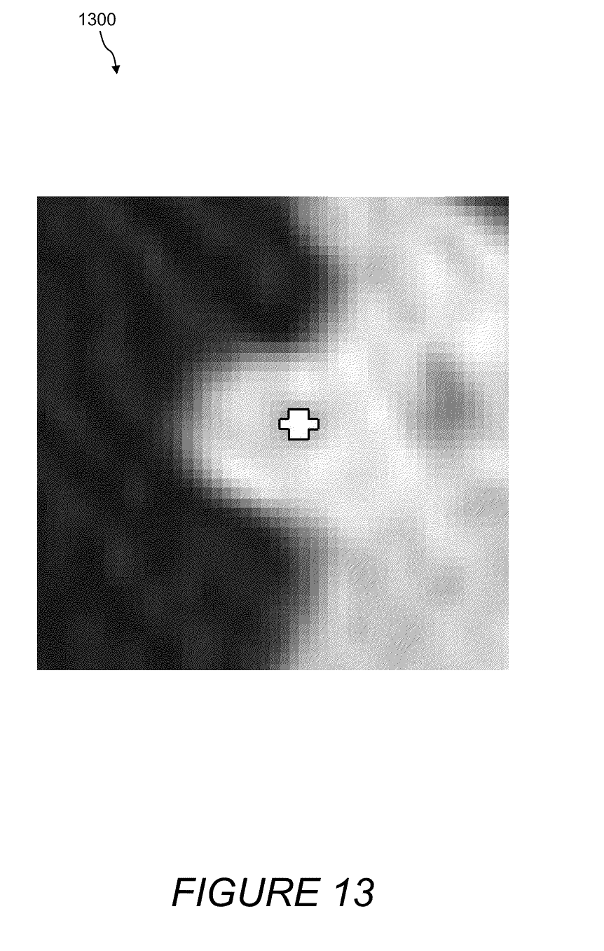

Finally, the size and relative intensity of individual regions of air pocket pixels or voxels are evaluated at step 1130. Those individual regions of sufficient size and relatively low intensity with respect to neighboring pixels or voxels may be designated as a valid air pocket and not merely the edge of a depression occurring due to natural gradation. Regions with a size of at least 2 mm² may be considered. To identify surrounding or neighboring pixels or voxels for consideration in the relative intensity measurement determination, each individual candidate air pocket ROI may be dilated using a mathematical morphological operation, for example. The median intensity value of the pixels or voxels of the candidate air pocket ROI may then be compared to the median intensity value of the neighboring pixels or voxels obtained through dilation. If this comparison indicates that the intensity of the candidate air pocket ROI is relatively low compared with the intensity of its neighboring region (e.g., below a threshold), the candidate air pocket ROI may be determined to be a true air pocket. For illustrative purposes, FIG. 13 shows an image slice 1300 of the ROI illustrated in FIG. 12 in which a boundary of a single region considered to be an air pocket of the ROI is highlighted after the image processing steps described herein were performed. Of course, other parameters and/or image processing techniques could be used to detect air pockets.

In certain virtual colonography images, such as those acquired using a decreased radiation dose, there may be so much increased noise that almost any ROI may appear to have air pocket features. In such virtual colonography images, air pocket analysis may be avoided. Although information regarding the radiation dose may be available from a header file of the image data, the actual image noise may further vary as a function of patient size, presence of an implant, etc. Therefore, a technique for estimating the noise is to process the image itself. For example, the distribution of intensity values of the air of the colon may be evaluated to estimate noise, since air voxels have intensity values that are consistent when low amounts of noise are present. An image mask of the air of the colon may be obtained using image processing techniques known in the art, one example of which is described in pending U.S. patent application Ser. No. 12/362,111, “COMPUTER-AIDED DETECTION OF FOLDS IN MEDICAL IMAGERY OF THE COLON,” supra. Other techniques may be used to identify the air of the colon. A determination that the amount of measured noise is excessive may be made by evaluating the number of objects or regions of a predetermined minimum size in the colon air mask that exceed an intensity threshold of −750 HU. Through one optimization experiment, a finding of more than 50 objects of at least 5 voxels in an isotropic volume was determined to be useful in distinguishing images with excessive noise levels that could not be suitably processed for air pockets from those that could. Other techniques known to persons of skill in the art may be used to quantify the amount of image noise from the air of the colon.

Again referencing FIG. 6, at step 630, classification of ROIs is performed using information from the computed tagging material and computed air pocket features. In an embodiment, a hard or “yes/no” classification decision may be accomplished by independently evaluating the information in a serial process. In other words, a candidate ROI may be classified as a non-polyp or stool if either computed tagging material or air pocket features satisfy predetermined classification conditions. By way of one example, the conditions may be: (1) the amount of measured tagging material exceeds a predetermined threshold; or (2) at least one air pocket can be segmented from the candidate ROI. Alternatively, a candidate ROI may be classified as a non-polyp or stool if both computed tagging material and air pocket features satisfy classification conditions. In other embodiments, information from both techniques may be combined to compute ROI classification. In other embodiments, soft classification decisions such as probabilities may be output from the above techniques.

While features characterizing the presence (or absence) of tagged material at predetermined locations of an ROI may provide information of use in classifying the ROI, features characterizing the amount of tagged material may provide further useful classification information. In particular, it has been discovered that although the presence of tagging agent on the backside of a structure may be a feature more commonly exhibited by stool structures, tagged residue may also appear on the backside of colonic polyps. Therefore, simply relying on the presence of tagged material has the potential to falsely classify some true colonic polyps as negatives (i.e., stool). In systems designed to detect colonic polyps in imagery, this is an example of the undesirable false negative problem (e.g., a true polyp falsely characterized as a negative).

A feature comparing the relative amount of tagging agent on the backside surface of the ROI may be used to overcome this problem. In one embodiment, the feature may be a percentage derived from a ratio of the count of tagging agent backside pixels or voxels to the count of all backside pixels or voxels. One classification technique, for example, may involve comparing this percentage alone against a threshold. Based on one optimization experiment, a predetermined percentage threshold of approximately 20% may be useful. If the measured backside feature characteristic meets this threshold, the anomaly is likely to be stool as opposed to non-stool.

Although the false negative problem may be improved using this minimum percentage backside tagged material feature characteristic, it was further discovered that a class of poorly tagged stool may have some backside tagging agent, but less than the predetermined threshold for the above determination.

However, colonic stool with some backside tagging agent may be likely to also exhibit some frontside tagging. Therefore, features derived from both the backside tagging agent and the frontside tagging agent may be of use in distinguishing stool that has backside tagging below the threshold percentage used to identify stool based solely on backside tagging agent. One classification technique, for example, may involve comparing both feature characteristics in isolation against separate thresholds. If both feature characteristics meet their threshold, the anomaly is likely to be stool. Based on one optimization experiment, respective thresholds of 10% for both frontside and backside agent may be useful. In sum, classification using either the presence of a minimum amount of backside tagging agent alone or the combined presence of both a (lesser) minimum of backside and of frontside tagging agent may be of use in discriminating stool from non-stool. Of course, both tests may be used serially or in combination to provide greater discrimination power.

In other embodiments, a candidate ROI may be classified as stool by jointly evaluating features derived from both tagging material and air pocket feature detection processes. Features used may include, but are not limited to, number of air pockets segmented; air pocket size features; intensity statistic features comparing tagging material intensity to candidate ROI intensity, etc.

### Exemplary Cluster-Based Feature Classification Methods

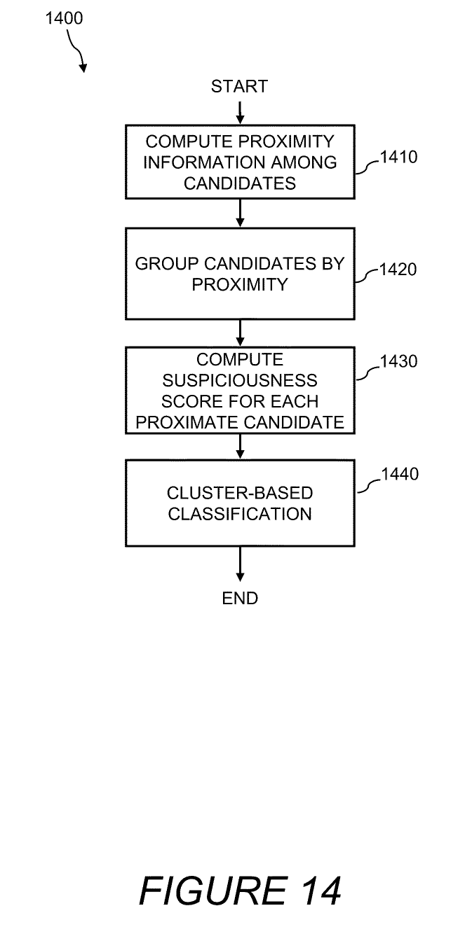

FIG. 14 illustrates steps that may be performed in one embodiment by cluster-based feature classification module 120 to apply image feature-based classification logic to those candidate ROIs that appear in clusters or groups.

Considering the medical image itself as a coordinate system, each candidate ROI has an absolute location or position that relates to the exact physical location or position of the anomaly in the patient's colon, and also has a location or position relative to every other candidate ROI identified in the colon. In accordance with an embodiment of this disclosure, these relative locations may be quantified at step 1410 by determining the number of volumetric elements (voxels) or pixels between candidate ROIs, such as to/from centroid voxels or centroid pixels of regions. These initial measurements may be converted to a physical measurement of length, such as centimeters or millimeters, as a function of the inter-pixel and inter-slice spacing of the medical image. These measurements may be stored in memory as a simple array, for example. The present disclosure may refer to this computed array of relative locations among identified candidate ROIs as proximity information. In other words, the array describes how proximate candidate ROIs are to one another.

Using the computed proximity information, the candidate ROIs may then be logically segmented into initial classes at step 1420. In an embodiment, a binary class assignment may be used, whereby candidate ROIs within a predetermined proximity or distance metric of one another are grouped together as part of a cluster of proximate candidate ROIs. More than one cluster may be identified in a given image. All other candidates not forming part of a cluster are part of a class comprising isolated or “non-clustered” candidate ROIs.

The choice of the proximity or distance metric may impact the accuracy of the classification embodiments of FIG. 14. If the metric is too large, true polyps may be classified as proximate and will therefore be classified in clusters, potentially leading to the undesirable problem of false negatives depending on further processing. If the metric is too small, however, very few or no candidate ROIs may be classified as clustered, producing little to no desirable false positive reduction effect from this clustering analysis. The optimal metric may further be dependent on the number of candidate ROIs input for evaluation. As the average number of candidates is increased, the distance metric may be decreased in order to optimize the sensitivity and false positive rate of the classification techniques disclosed hereinbelow.

In accordance with one embodiment of the disclosure, a proximity or distance metric of approximately 3 cm may be utilized at an optimal range of 10-30 false positives identified per series. Rather than require all candidate ROIs to be located within an approximately 3 cm radius, candidate ROIs may be classified as proximate if they are “chained” such that individual candidates are within an approximately 3 cm radius from at least one other individual candidate. By way of a specific example of “chaining,” two candidate ROIs located 6 cm from one another may be classified as proximate if a third candidate ROI is located 3 cm from the first candidate and 3 cm from the second candidate. However, this rule and supporting example for application of the metric to proximate class assignment is merely exemplary; alternatively, “chaining” may not be permitted.

The remaining steps of FIG. 14 are then performed on a cluster-by-cluster basis. At step 1430, for each candidate ROI in a particular cluster, a suspiciousness score is computed based on image-based feature information for that candidate, in order to enable a standardized comparison of suspiciousness among all proximate candidates in a cluster. The term “suspiciousness score” simply refers to a quantitative measurement or measurements describing the similarity in the derived features between an individual candidate ROI and a labeled class (e.g., true colonic polyps) known a priori. In the identification of colonic polyps, there are numerous ways to compute a suspiciousness score from individual candidates, and any such technique may be employed at step 1430. In accordance with one embodiment of this disclosure, a suspiciousness score may be computed from feature information extracted from each anomaly. As is known, extraction is a term of art that refers to the computation of statistical feature information from a region of interest. In accordance with an embodiment of the disclosure, exemplary features that may be extracted include statistics describing the curvature, shape index, intensity, spatial gray-level dependence (SGLD), and/or structure tensor of the voxels of the anomaly, computations for which are all well-described in the prior art. These features, however, are merely presented as examples and other features may equally be used in the technique. By way of another example, features from a previous computation stage, such as curvature or shape index feature values computed by candidate ROI detector module 112, may be retrieved from storage and utilized for computing a suspiciousness score. The suspiciousness score may be computed by inputting any such features or collection of features (e.g., as a feature vector) to a statistical classification algorithm trained from the features of the labeled class of true colonic polyps. A quadratic classifier or a group of quadratic classifiers acting as members may be used, for example. Other examples of suitable classification algorithms are presented in Pattern Classification, Duda et al., John Wiley & Sons, New York, October 2000. The suspiciousness score may be expressed, for example, as a difference of discriminants. This difference of discriminants may but need not be transformed to lie between 0 and 1. The difference of discriminants may be expressed as the difference between the distance that the computed features of a candidate suspicious anomaly lie in feature space from the features of the colonic polyp class model and from the features of a non-polyp class model. For example, in embodiments in which a quadratic classifier may be used, both a mean and a variance estimate for each labeled class may be included in the classification algorithm model and utilized to produce the difference of discriminants. Other techniques may also be used, as will be known to persons of skill in the art.

All suspiciousness scores for members of a cluster may then be input to a classification step 1440, which outputs a classification decision for all candidates in a cluster. While other algorithms may be utilized, one exemplary approach is to use the suspiciousness scores of all ROIs in a cluster collectively to allow classification decisions to be made for one ROI based on an evaluation of suspiciousness of all ROIs in the cluster. Thus, rather than analyzing suspiciousness of a single candidate in isolation to make a decision about that ROI, suspiciousness of the cluster ROIs can be analyzed together to make class decisions for the cluster members.

In an embodiment, the classification algorithm employed may be a series of decision rules and there may be only a hard or “yes/no” classification decision output. A decision rule is a simple form of classification that may be described as taking the form: IF condition₁ AND condition₂ AND . . . AND conditionₙ THEN CLASS=classᵢ ELSE CLASS=classⱼ. Several advantages of utilizing a decision rule include that it is computationally fast and is less likely to suffer from unexpected behavior due to overtraining. However, other classification algorithms besides decision rules could be employed to model the cluster-based classification logic described hereinabove.

In a decision rule classification approach, a first decision rule may be to classify as non-polyps all candidates ROI in a cluster that do not have the absolute highest difference of discriminants of all the candidate ROIs in the cluster. That is to say, all but the “most suspicious” ROI in the cluster are classified as potential non-polyps regardless of their actual suspiciousness. Based on our experiments, a substantial number of false polyps were eliminated by this approach. A second decision rule may then be to re-classify those ROIs initially classified as non-polyps by the first rule back to being candidate ROIs if they have a difference of discriminants that exceeds a predetermined threshold. That is to say, all ROIs in the cluster that exceed a certain level of suspiciousness are classified as potential polyps regardless of their relative suspiciousness compared to other cluster members. Based on our experiments, the second rule recaptures true polyps that do not have the highest difference of discriminants and that would have otherwise been falsely eliminated as non-polyps by the first rule. This, of course, means that there were instances of multiple true polyps appearing in the same cluster.

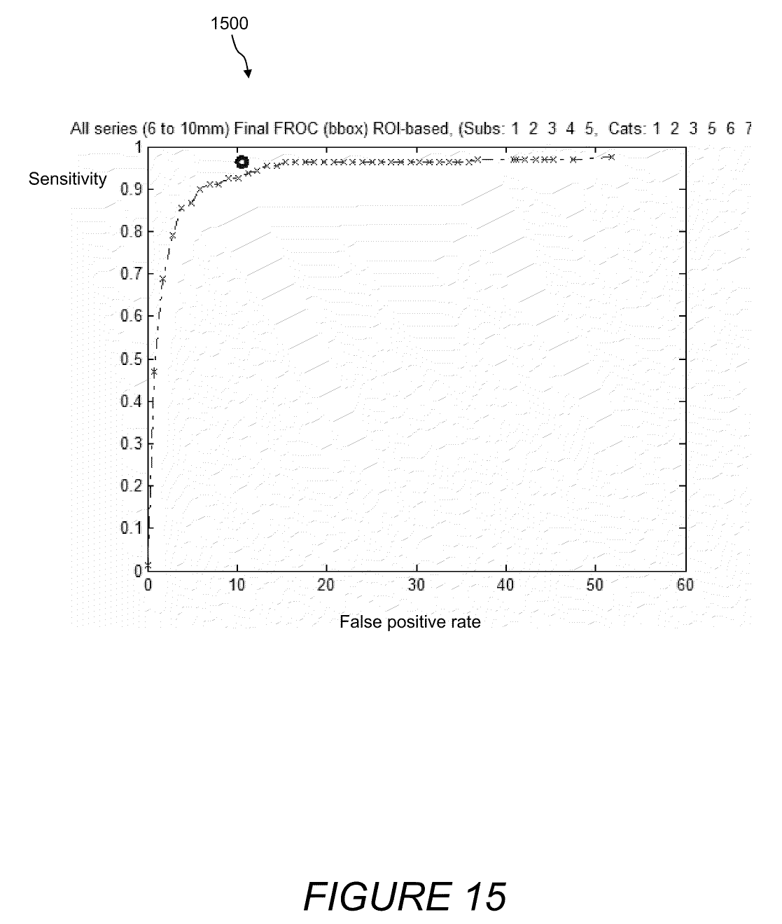

FIG. 15 is a free-response operating curve (FROC) 1500 illustrating performance results for polyps of sizes 6-10 mm when the methods disclosed herein were applied to a statistically significant testing set of polyps. FIG. 15 illustrates that, according to the results from one experiment, the number of false positives could be reduced by nearly 33% with zero loss in sensitivity. In particular, the series of points in FIG. 15 illustrates performance of a classification module such as polyp classification module 122 before cluster-based feature classification module 120 was implemented on polyps 6-10 mm. The black dot, on the other hand, represents performance of a classification module such as polyp classification module 122 at one operating point after cluster-based feature classification module 120 was implemented. Drawing a horizontal line that intersects both the black dot and the curve represented by the other points, it can be seen that the false positive rate drops to about 10-11 FP from 15-16 FP per series with no loss in sensitivity, indicating about a 33% FP reduction. Upon reviewing the false positives eliminated, we found that a substantial number of 6-10 mm stool- and distention-related anomalies could be successfully identified as true negatives using this classification technique.

### Multi-Level Classification of Detected Candidate Polyps

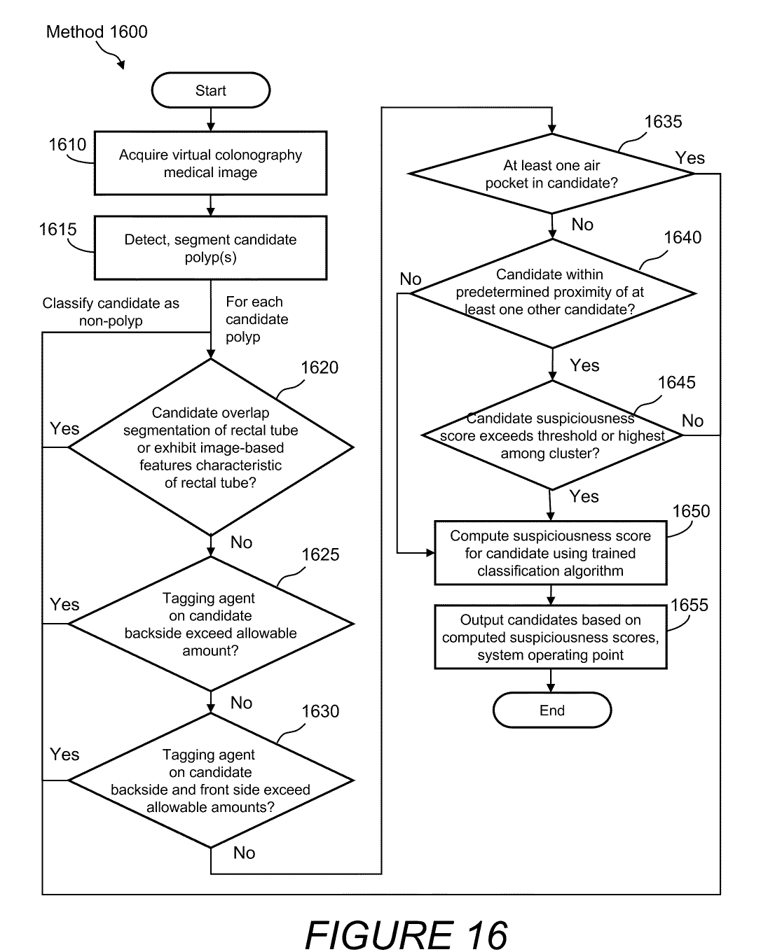

FIG. 16 is a flowchart of a suspicious polyp identification and output process that utilizes embodiments of the various individual image processing functions described herein. More specifically, the suspicious polyp identification process utilizes embodiments of the classification modules described hereinabove as part of a multi-level scheme in which a different principle is utilized at each stage of classification to distinguish polyps from non-polyps. The steps may be described with continuing reference to FIGS. 1-14.

At step 1610, a virtual colonography medical image is received by system 100 of FIG. 1 from a memory that stores the image data or directly from an input device that generates the image data. Exemplary memories and input devices suitable for performing such a step were described with reference to FIG. 1.

At step 1615, a plurality of candidate polyps are detected and segmented from a virtual colonography image using image processing techniques known in the art, examples of which are presented hereinabove with reference to candidate ROI detector module 112 of FIG. 1.

Steps 1620-1645 are individual stages of classification that are then performed on an individual or “for-each” candidate polyp basis (unless otherwise noted). Each of steps 1620-1635 may be formed for all candidate polyps before moving to the next step, or alternatively steps 1620-1635 may be formed serially for one candidate polyp before returning to analyze a subsequent candidate polyp. At step 1620, it is determined whether the candidate polyp either overlaps a segmentation of the rectal tube or exhibits an ROI shape-texture discriminant score above a classification threshold with respect to rectal tube features. If either condition is met, the candidate polyp may be classified as being of non-interest and the method may proceed to the next candidate polyp detected. Otherwise, the candidate polyp may be classified as being still of interest and the method may continue.

At step 1625, the relative amount of tagging agent on the backside of the candidate is measured. The feature may be computed as a percentage from a ratio of the count of tagging agent backside pixels or voxels to the count of all backside pixels or voxels. If more than about 20% of the backside of the candidate is determined to be tagging agent, the candidate polyp may be classified as being of non-interest and the method may proceed to the next candidate polyp detected.

At step 1630, the amount of tagging agent on the frontside of the candidate is measured. The feature may be computed as a percentage from a ratio of the count of tagging agent frontside pixels or voxels to the count of all frontside pixels or voxels. If more than about 10% of the frontside and more than about 10% of the backside of the candidate are both determined to be tagging agent, the candidate polyp may be classified as being of non-interest and the method may proceed to next candidate polyp detected. Otherwise, the candidate polyp may be classified as being still of interest and the method may proceed.

At step 1635, it is determined if at least one air pocket is present in the interior of the candidate. If at least one such air pocket can be detected, the candidate polyp may be classified as being of non-interest and the method may proceed to the next candidate polyp detected. Otherwise, the candidate polyp may be classified as being still of interest and the method may proceed.

At step 1640, which in an embodiment is performed after steps 1620-1635 have been performed for all candidate polyps, and non-polyps which are detected by those steps are eliminated from further consideration, it is determined whether a remaining candidate polyp appears within a predetermined distance from at least one other remaining candidate. If so, the candidate polyp may be classified as being part of a cluster of candidate polyps. After all remaining candidate polyps are thus analyzed, the method proceeds to step 1645.

At step 1645, it is determined whether a candidate polyp may be characterized as either (1) having the highest feature suspiciousness score among the cluster of candidate polyps to which it was classified, or (2) as having a feature suspiciousness score that exceeds a predetermined cluster suspiciousness threshold. If neither condition is met, the candidate polyp may be classified as being of non-interest. Otherwise (that is, if either condition is met), the candidate polyp may be classified as being still of interest. This step may be repeated for all candidate polyps determined to be in clusters before proceeding to step 1650.

At step 1650, a suspiciousness score indicating a probability of being a polyp is computed for each candidate polyp still of interest. In accordance with an embodiment, the polyp probability score is computed based on a set of image-based features for each candidate ROI. Exemplary image-based features may include morphology or shape-based features, such as curvature, aspect ratio, shape similarity, radial symmetry, and/or structure tensor statistics; texture-based features, such as intensity and/or spatial gray level dependence (SGLD) statistics; and/or volumetric-based features, such as surface area, volume, diameter, and/or inner-wall area statistics. These features may be computed on a per-voxel basis for a given candidate ROI, and may be summarized by simple statistics (e.g. mean, maximum, minimum, standard deviation, skewness, kurtosis). In an embodiment, a committee of classification algorithms may be employed to compute a polyp probability score from the aforementioned features.

There may be several advantages gained by computing polyp probability scores only on those candidates that were not classified as being of non-interest (i.e., false positives) by previous steps. One advantage is the ability to save computationally-intensive feature computations for a smaller number of image ROI candidates. In addition, because members of the classes of false positives eliminated by previous steps may mimic image-based feature characteristics of true polyps, another advantage may be the ability to withhold certain false positive classes from the class of non-polyps presented to train a classification algorithm or algorithms. An improved discrimination boundary or boundaries may thus be formed without the influence of the shape, texture, volume, or other image-based feature values derived from the eliminated false positive classes. Comparing measured features against this boundary may result in a reduction of false negatives, leading to a sensitivity improvement by the committee or other trained classification algorithm utilized.

As discussed above, suspiciousness score indicating a probability of being a polyp optionally may be computed before the FP classification modules, or between FP classification modules, and the FP classification modules may be executed in orders different than that described herein.

At step 1655, regions or features of interest in the virtual colonography medical image (or portions thereof) may be annotated or marked in response to the outcome of feature detection and/or classification. In the field of computer-aided detection (CAD), annotations identifying regions of interest are often known as “CAD marks.” By way of one example, an ROI may be annotated with an image mark if the polyp probability score computed for the ROI exceeds a threshold determined as a function of a system operating point. By way of another example, a label that designates a specific class assignment for a region of interest may be provided, which may be particularly useful if classification information regarding more than one type of region of interest (e.g., suspicious polyps, suspicious stool) should be displayed. Labels could of course be substituted or supplemented using alternative types of markings to convey information such as, but not limited to, distinct colors, symbols, or intensities.

Furthermore, any features evaluated during classification may be annotated, marked, or displayed in a way that conveys the characteristic of interest. By way of one example and not by limitation, the specific pixels or voxels segmented as either the air pocket or the tagged material feature characteristic within a given ROI may be highlighted as a feature of interest. Highlighting of such information may be particularly important in a three-dimensional depiction of the colonic ROI, such as a three-dimensional endoscopic or a three-dimensional filet view of the colon, as these three-dimensional depictions typically do not render the pixels or voxels of tagged material in such a way to convey the original, high intensity values of tagged residue. Therefore, during interpretation, a radiologist who utilizes a three-dimensional depiction cannot readily see the appearance of tagged material or air pockets until he or she further consults an original two-dimensional slice image (e.g., a CT sagittal, coronal, or axial slice) at the same corresponding location. Thus, highlighting of such detected features distinctly on a three-dimensional output image may provide a useful interpretation tool for the radiologist.

### Alternate Embodiments of Virtual Colonography Image Processing Systems

FIG. 17 illustrates an alternate embodiment of a system 1700 in which the steps of acquiring, processing, and outputting virtual colonography medical image data may be distributed amongst different exemplary sub-systems, each of which may have combinations of hardware or software. In system 1700, there is shown an image acquisition unit 1710, an image processing apparatus 1720, and an output device 1730.

Image acquisition unit 1710 is representative of a source for acquiring medical image data of a colon in digital form (i.e., virtual colonography medical image data). Such sources use non-invasive imaging procedures such as computed tomography (CT), magnetic resonance imaging (MRI), or another suitable virtual method for creating images of a patient's abdominal and colonic regions as will be known to a person of skill in the art. Examples of vendors that provide CT and MRI scanners include, for example, the General Electric Company of Waukesha, Wis. (GE); Siemens AG of Erlangen, Germany (Siemens); and Koninklijke Philips Electronics of Amsterdam, Netherlands. As further part of image acquisition unit 1710, there is shown an image reconstruction unit 1712 for converting two-dimensional virtual colonography image data that may be acquired by image acquisition unit 1710 (e.g., CT x-ray images taken around a single axis of rotation) to three-dimensional virtual colonography image data. For example, image reconstruction unit 1712 may comprise software for constructing a three-dimensional virtual colonography volume of pixel or voxel image data by performing a filtered backprojection or other suitable volumetric reconstruction algorithm on the two-dimensional virtual colonography image data. Of course, such unit may be independent, may be joined with image acquisition unit 1710, or may be joined with image processing apparatus 1720.

Image processing apparatus 1720 is representative of a computer system that can process the virtual colonography medical imagery by executing the various program instructions described herein. Image processing apparatus 1720 can further transmit the results of processing in the form of various signals to a device for output. One example of a suitable image processing apparatus is system 100 described hereinabove with reference to FIG. 1.

Output device 1730 is representative of an apparatus that can output virtual colonography medical image data and results of processing by image processing apparatus 1720. Output device 1730 may allow a radiologist or other user to review the virtual colonography image data and any results of processing for purposes of examination and diagnosis of the colon. For example, output device 1730 may be a visual display unit such as a cathode ray tube (CRT) or liquid crystal display (LCD) monitor. Output device 1730 may alternatively be deployed as part of a separate computer system from image processing apparatus 1720, such as a medical image review workstation system. Medical image review workstations typically comprise software for constructing additional virtual colonography imagery better suited for visualization and virtual navigation through the colon. Thus, output device 1730 may receive data directly or indirectly from image processing apparatus 1720.

Image acquisition unit 1710, image processing apparatus 1720, and output device 1730 may connect to and communicate with one another via any type of communication interface, including but not limited to, physical interfaces, network interfaces, software interfaces, and the like. The communication may be by means of a physical connection, or may be wireless, optical or of any other means. For example, if image acquisition unit 1710 is connected to image processing apparatus 1720 by means of a network or other direct computer connection, the network interface or other connection means may be the input device for image processing apparatus 1720 to receive imagery for processing by the methods and systems disclosed herein. Alternatively, image processing apparatus 1720 may receive images for processing indirectly from image acquisition unit 1710, as by means of transportable storage devices (not shown in FIG. 17) such as but not limited to CDs, DVDs or flash drives, in which case readers for said transportable storage devices may function as input devices for image processing apparatus 1720 for processing images according to the methods disclosed herein.

Other devices not shown in FIG. 17, such as but not limited to a Picture Archiving and Communications Device (PACS), could also be utilized for secondary storage of the medical imagery and/or processing results obtained by image acquisition unit 1710, image processing apparatus 1720, and/or output device 1730.

Having described the present invention herein in detail and by reference to specific embodiments thereof, it will be apparent that modifications and variations are possible without departing from the scope of this disclosure.

1. In a system comprising at least one processor, at least one input device and at least one output device, a method of detecting regions of interest in a colonographic image, comprising:
a. by means of an input device, acquiring colonographic image data;
b. by means of a processor, detecting a plurality of candidate regions of interest from the colonographic image data;
c. by means of a processor, for each of the plurality of candidate regions of interest, classifying said candidate region of interest into a class belonging to a set of classes comprising a first class of regions of interest for further analysis and a remainder class of regions of interest not for further analysis, wherein classification of a candidate region of interest is based upon at least one of:
i) determining a likelihood that said candidate region of interest is a portion of a rectal tube, by means of (A) measuring at least one feature of said candidate region of interest, other than its overlap with said rectal tube; and (B) comparing said measured feature(s) with at least one predetermined threshold;
ii) determining a likelihood that said candidate region of interest has at least one feature characteristic of stool; and
iii) determining a likelihood that said candidate region of interest is a member of a cluster and is not for further analysis; and
d. by means of an output device, outputting, to at least one user, information associated with at least one candidate region of interest in the first class.

2. The method of claim 1, wherein the colonographic image data is acquired by means of an image acquisition unit.

3. The method of claim 1, wherein the colonographic image data comprises a colonographic volume.

4. The method of claim 3, wherein the colonographic volume is acquired by means of an image acquisition unit obtaining a plurality of two-dimensional images of an anatomical colon, and a processor computing the colonographic volume from the plurality of two-dimensional images.

5. The method of claim 1, wherein the colonographic image data is acquired from at least one of a computer network and a storage device.

6. The method of claim 1, further comprising, by means of a processor, for each candidate region of interest in the first class, analyzing said candidate region of interest, determining a suspiciousness that said candidate region is a polyp and, based upon said suspiciousness, leaving said candidate region of interest in the first class or removing said candidate region of interest from the first class.

7. The method of claim 1, wherein determining a likelihood that said candidate region of interest is a portion of a rectal tube further comprises determining a likelihood that said candidate region of interest overlaps the rectal tube.

8. The method of claim 1, wherein measuring at least one feature of said candidate region of interest comprises measuring at least one of a shape feature and a texture feature.

9. The method of claim 8, wherein measuring a shape feature comprises measuring at least one of a curvature and a curvedness.

10. The method of claim 8, wherein measuring a texture feature comprises measuring at least one of a range, a spread and a distribution of intensity values.

11. The method of claim 1, wherein comparing said measured feature(s) with at least one predetermined threshold comprises forming a discriminant score from a plurality of features.

12. The method of claim 11, wherein forming a discriminant score from a plurality of features comprises forming a discriminant score from at least one shape feature and at least one texture feature.

13. The method of claim 1, wherein determining a likelihood that said candidate region of interest has at least one feature characteristic of stool comprises at least one of
c) ii) A) (I) measuring at least one feature characteristic of tagged material; and
(II) comparing said measured feature(s) with at least one predetermined threshold; and
c) ii) B) (I) measuring at least one air pocket feature; and
(II) comparing said measured feature(s) with at least one predetermined threshold.

14. The method of claim 13, wherein measuring at least one feature characteristic of tagged material comprises measuring at least one feature characteristic of material tagged at the back side of said candidate region of interest.

15. The method of claim 14, wherein measuring at least one feature characteristic of material tagged at the back side of said candidate region of interest comprises measuring at least one intensity value of at least a portion of said back side.

16. The method of claim 15, wherein comparing said measured feature(s) with at least one predetermined threshold comprises measuring an amount of material for which an intensity value exceeds a threshold.

17. The method of claim 14, further comprising measuring at least one feature characteristic of material tagged at the front side of said candidate region of interest.

18. The method of claim 17, wherein measuring at least one feature characteristic of material tagged at the front side of said candidate region of interest comprises measuring at least one intensity value of at least a portion of said front side.

19. The method of claim 18, wherein comparing said measured feature(s) with at least one predetermined threshold comprises measuring an amount of tagged material.

20. The method of claim 13, wherein measuring at least one air pocket feature comprises measuring at least one intensity value of an interior of the candidate region of interest.

21. The method of claim 20, wherein comparing said measured feature(s) with at least one predetermined threshold comprises determining that at least a portion of the interior of the candidate region of interest has an intensity value below a surrounding region.

22. The method of claim 21, further comprising determining that said portion exceeds a predetermined size.

23. The method of claim 22, wherein said predetermined size is about 2 mm.

24. The method of claim 13, wherein determining a likelihood that said candidate region of interest has at least one feature characteristic of stool comprises determining that said measured tagged material feature(s) exceeds at least one predetermined threshold, and that said air pocket feature(s) exceeds at least one predetermined threshold.

25. The method of claim 1, wherein determining a likelihood that said candidate region of interest is a member of a cluster and is not for further analysis comprises
c) iii) A) determining that said candidate region is within a predetermined distance of at least one other candidate region, and assigning said candidate region and said at least one other candidate region within a predetermined distance thereof to the cluster;
c) iii) B) determining a suspiciousness score for said candidate region; and
c) iii) C) determining a likelihood that said candidate region is not for further analysis based upon its suspiciousness score.

26. The method of claim 25, wherein determining a likelihood that said candidate region is not for further analysis based upon its suspiciousness score comprises at least one of:
c) iii) C) (I) comparing the suspiciousness scores of all candidate regions within the cluster and determining that said candidate region suspiciousness score is not highest; and
c) iii) C) (II) comparing the suspiciousness score of said candidate region to a threshold and determining that said candidate region suspiciousness score is below the threshold.

27. The method of claim 26, wherein determining a likelihood that said candidate region is not for further analysis based upon its suspiciousness score comprises determining that said candidate region suspiciousness score is not highest; and determining that said candidate region suspiciousness score is below the threshold.

28. The method of claim 1, wherein classifying said candidate region of interest into a class belonging to a set of classes comprising a first class of regions of interest and a remainder class of regions of interest is based upon:
i) determining a likelihood that said candidate region of interest is a portion of a rectal tube, by means of (A) measuring at least one feature of said candidate region of interest, other than its overlap with said rectal tube; and (B) comparing said measured feature(s) with at least one predetermined threshold;
ii) determining a likelihood that said candidate region of interest has at least one feature characteristic of stool; and
iii) determining a likelihood that said candidate region of interest is a member of a cluster and is not for further analysis.

29. The method of claim 1, wherein detecting a plurality of candidate regions of interest from the colonographic image data comprises, for each of the plurality of candidate regions of interest, analyzing said candidate region of interest and determining a suspiciousness that said candidate region is a polyp.

30. In a system comprising at least one processor, at least one input device and at least one output device, a method of detecting regions of interest in a colonographic image, comprising:
a. by means of an input device, acquiring a virtual colonography medical image;
b. by means of a processor, detecting a candidate region of interest from the image;
c. by means of a processor, determining that said candidate region of interest is not a portion of a rectal tube;
d. by means of a processor, determining that said candidate region of interest does not have a feature characteristic of stool;
e. by means of a processor, determining that said candidate region of interest is not both
(1) a member of a cluster containing another candidate region of interest with a higher suspiciousness score; and
(2) characterized by a suspiciousness score below a threshold;
f. by means of a processor, determining a suspiciousness score that said candidate region of interest is a polyp; and
g. by means of an output device, outputting information associated with said candidate region of interest to a user.

31. A system for detecting regions of interest in a colonographic image, comprising:
a. at least one input device, configured to acquire colonographic image data;
b. at least one processor, configured to:
i) detect a plurality of candidate regions of interest from the colonographic image data; and
ii) for each of the plurality of candidate regions of interest, classify said candidate region of interest into a class belonging to a set of classes comprising a first class of regions of interest for further analysis and a remainder class of regions of interest not for further analysis, wherein classification of a candidate region of interest is based upon at least one of:
A) determining a likelihood that said candidate region of interest is a portion of a rectal tube, by means of (1) measuring at least one feature of said candidate region of interest, other than its overlap with said rectal tube; and (2) comparing said measured feature(s) with at least one predetermined threshold;
B) determining a likelihood that said candidate region of interest has at least one feature characteristic of stool; and
C) determining a likelihood that said candidate region of interest is a member of a cluster and is not for further analysis; and
c. at least one output device, configured to output, to at least one user, information associated with at least one candidate region of interest in the first class.

32. The system of claim 31, wherein the colonographic image data is acquired by means of an image acquisition unit.

33. The method of claim 31, wherein the colonographic image data comprises a colonographic volume.

34. The method of claim 33, wherein the colonographic volume is acquired by means of an image acquisition unit obtaining a plurality of two-dimensional images of an anatomical colon, and a processor computing the colonographic volume from the plurality of two-dimensional images.

35. The method of claim 31, wherein the colonographic image data is acquired from at least one of a computer network and a storage device.

36. The method of claim 31, wherein at least one processor is further configured to, for each candidate region of interest in the first class, analyze said candidate region of interest, determine a suspiciousness that said candidate region is a polyp and, based upon said suspiciousness, leave said candidate region of interest in the first class or remove said candidate region of interest from the first class.

37. The method of claim 31, wherein determining a likelihood that said candidate region of interest is a portion of a rectal tube further comprises determining a likelihood that said candidate region of interest overlaps the rectal tube.

38. The method of claim 31, wherein measuring at least one feature of said candidate region of interest comprises measuring at least one of a shape feature and a texture feature.

39. The method of claim 38, wherein measuring a shape feature comprises measuring at least one of a curvature and a curvedness.

40. The method of claim 38, wherein measuring a texture feature comprises measuring at least one of a range, a spread and a distribution of intensity values.

41. The method of claim 31, wherein comparing said measured feature(s) with at least one predetermined threshold comprises forming a discriminant score from a plurality of features.

42. The method of claim 41, wherein forming a discriminant score from a plurality of features comprises forming a discriminant score from at least one shape feature and at least one texture feature.

43. The method of claim 31, wherein determining a likelihood that said candidate region of interest has at least one feature characteristic of stool comprises at least one of
c) ii) A) (I) measuring at least one feature characteristic of tagged material; and
(II) comparing said measured feature(s) with at least one predetermined threshold; and
c) ii) B) (I) measuring at least one air pocket feature; and
(II) comparing said measured feature(s) with at least one predetermined threshold.

44. The method of claim 43, wherein measuring at least one feature characteristic of tagged material comprises measuring at least one feature characteristic of material tagged at the back side of said candidate region of interest.

45. The method of claim 44, wherein measuring at least one feature characteristic of material tagged at the back side of said candidate region of interest comprises measuring at least one intensity value of at least a portion of said back side.

46. The method of claim 45, wherein comparing said measured feature(s) with at least one predetermined threshold comprises measuring an amount of material for which an intensity value exceeds a threshold.

47. The method of claim 44, wherein at least one processor is further configured to measure at least one feature characteristic of material tagged at the front side of said candidate region of interest.

48. The method of claim 47, wherein measuring at least one feature characteristic of material tagged at the front side of said candidate region of interest comprises measuring at least one intensity value of at least a portion of said front side.

49. The method of claim 48, wherein comparing said measured feature(s) with at least one predetermined threshold comprises measuring an amount of tagged material.

50. The method of claim 43, wherein measuring at least one air pocket feature comprises measuring at least one intensity value of an interior of the candidate region of interest.

51. The method of claim 50, wherein comparing said measured feature(s) with at least one predetermined threshold comprises determining that at least a portion of the interior of the candidate region of interest has an intensity value below a surrounding region.

52. The method of claim 51, wherein at least one processor is further configured to determine that said portion exceeds a predetermined size.

53. The method of claim 52, wherein said predetermined size is about 2 mm.

54. The method of claim 43, wherein determining a likelihood that said candidate region of interest has at least one feature characteristic of stool comprises determining that said measured tagged material feature(s) exceeds at least one predetermined threshold, and that said air pocket feature(s) exceeds at least one predetermined threshold.

55. The method of claim 31, wherein determining a likelihood that said candidate region of interest is a member of a cluster and is not for further analysis comprises
c) iii) A) determining that said candidate region is within a predetermined distance of at least one other candidate region, and assigning said candidate region and said at least one other candidate region within a predetermined distance thereof to the cluster;
c) iii) B) determining a suspiciousness score for said candidate region; and
c) iii) C) determining a likelihood that said candidate region is not for further analysis based upon its suspiciousness score.

56. The method of claim 55, wherein determining a likelihood that said candidate region is not for further analysis based upon its suspiciousness score comprises at least one of:
c) iii) C) (I) comparing the suspiciousness scores of all candidate regions within the cluster and determining that said candidate region suspiciousness score is not highest; and
c) iii) C) (II) comparing the suspiciousness score of said candidate region to a threshold and determining that said candidate region suspiciousness score is below the threshold.

57. The method of claim 56, wherein determining a likelihood that said candidate region is not for further analysis based upon its suspiciousness score comprises determining that said candidate region suspiciousness score is not highest; and determining that said candidate region suspiciousness score is below the threshold.

58. The method of claim 31, wherein classifying said candidate region of interest into a class belonging to a set of classes comprising a first class of regions of interest and a remainder class of regions of interest is based upon:
i) determining a likelihood that said candidate region of interest is a portion of a rectal tube, by means of (A) measuring at least one feature of said candidate region of interest, other than its overlap with said rectal tube; and (B) comparing said measured feature(s) with at least one predetermined threshold;
ii) determining a likelihood that said candidate region of interest has at least one feature characteristic of stool; and
iii) determining a likelihood that said candidate region of interest is a member of a cluster and is not for further analysis.

59. The method of claim 31, wherein detecting a plurality of candidate regions of interest from the colonographic image data comprises, for each of the plurality of candidate regions of interest, analyzing said candidate region of interest and determining a suspiciousness that said candidate region is a polyp.

60. A system for detecting regions of interest in a colonographic image, comprising:
a. at least one input device, configured to acquire a virtual colonography medical image;
b. at least one processor, configured to:
i) detect a candidate region of interest from the image;
ii) determine that said candidate region of interest is not a portion of a rectal tube;
iii) determine that said candidate region of interest does not have a feature characteristic of stool;
iv) determine that said candidate region of interest is not both (1) a member of a cluster containing another candidate region of interest with a higher suspiciousness score; and (2) characterized by a suspiciousness score below a threshold; and
v) determine a suspiciousness score that said candidate region of interest is a polyp; and
c. at least one output device, configured to output information associated with said candidate region of interest to a user.
